(19) United States
(12) Patent Application Publication
(10) Pub. No.: US 2024/0327257 A1
(43) Pub. Date: Oct. 3, 2024

(54) Gated Electrodialysis with Zero Liquid Discharge

(71) Applicant: Ben Harrison Cantrell, Springfield, VA (US)

(72) Inventor: Ben Harrison Cantrell, Springfield, VA (US)

(21) Appl. No.: 18/128,382

(22) Filed: Mar. 30, 2023

(51) Int. Cl. C02F 1/469; C02F 1/26; C02F 1/42; C02F 1/52; C02F 1/66

(52) U.S. Cl. CPC C02F 1/4693; C02F 1/265; C02F 1/42; C02F 1/5209; C02F 1/66; C02F 2201/4611; C02F 2201/46115; C02F 2201/4617; C02F 2201/4618; C02F 2209/02

(57) ABSTRACT

This Gated Electrodialysis GED invention provides desalination of saline water while having only solid waste. The basic structure of an ordinary electrodialysis process is modified so that there is essentially no electrical power losses and no cross-water leakages in the concentrate, dilute, anolyte, and catholyte water distributions systems. Consequently, the concentrate water can be supersaturated while the dilute water can have any concentrations. Furthermore, the new process provides a means of operating such that the circulating concentrate supersaturated water can take tens of hours to flow through an enhanced clarifier. Consequently, there is time for solids to precipitate out of the concentrate supersaturated saline water and drift to the bottom of the enhanced clarifier and/or onto seed crystals before the concentrate water is reused. A representative design of this GED invention is given which is followed by the performance prediction for three examples.

### CROSS-REFERENCE TO RELATED APPLICATIONS

Not Applicable

### FEDERALLY SPONSORED RESEARCH OR DEVELOPMENT

Not applicable

### REFERENCE TO A “SEQUENCE LISTING”

Not Applicable

### NAMES OF THE PARTIES TO A JOINT RESEARCH AGREEMENT: Not Applicable INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND

### Field of the Invention

This invention is in the field of Zero Liquid Discharge ZLD electrodialysis with applications to desalination and water softeners.

### Description of the Related Art

Most “fresh” water having ion concentrations less than 500 parts per million ppm is derived from streams, ground water, and non-replenishable aquifers. This water is primarily used in residential, municipal, commercial, industrial, and agricultural applications. In some applications such as agricultural, this water does not need to be treated. In other cases, the water can be treated by traditional methods such as coagulation, flocculation, sedimentation, and filtering to remove natural contaminates. The water is then usually disinfected using techniques such as chlorination, or ozonation.

When fresh water is scare, there are large quantities of salt water in the oceans and aquifers that can be used after desalination treatment. The most common methods of desalination are distillation, Reverse Osmosis RO, and Electrodialysis or Electrodialysis Reversal ED/EDR. The common ways of operating these desalination systems results in desalinated water and waste water that might have a volume of on-the-order of half the feed water's volume but with a Total Dissolved Solids TDS concentrations on the order of twice the feed water's TDS. Although cost is sometimes an issue with desalination, another significant issue is the disposal of large quantities of ionized waste water. To solve this waste water problem, Zero Liquid Discharge ZLD processes have been described in the literature and have been implemented. Citation 1 in INFORMATION DISCLOSURE STATEMENT BY APPLICANT Form PTO/SB/08a (01-10) under NON-PATENT LITERATURE DOCUMENTS provides an overview of desalination with ZLD. There are at least two different methods of obtaining ZLD operation which are: (1) remove water from the ionized water solution until the remaining ions form solids through precipitation, or (2) transfer ions from the feed water into another ionized water solution, which is supersaturated and where solids are formed through precipitation. Most ZLD operations utilize the first method of removing water from the ionized water solution until solids form. These common processes rely on first desalination by either distillation, RO, or ED/EDR, followed by evaporation by some means, and finally removing the last amount of water with a crystallization process. In some cases, rather than use evaporation in the middle step, ED/EDR process can be used as described in Citation 1 in INFORMATION DISCLOSURE STATEMENT BY APPLICANT Form PTO/SB/08a (01-10) under NON-PATENT LITERATURE DOCUMENTS. This invention relies on the ZLD operation that transfers ions from the feed water into another ionized water solution which is supersaturated and where solids are formed through precipitation.

As a background to this invention, the characteristics of the types of waters involved in this invention are briefly discussed. The feed water to be desalinated is what is commonly called salt water which will be called the dilute water in this invention. It is formed by solids disassociating into ions in water. These ions disperse throughout the water and can move within it. Although, the invention will work with any ions, some of the common ions found in sea, brackish, and aquifers waters are cations such as Calcium (Ca), Magnesium (Mg), Sodium (Na), Iron (Fe), and Potassium (K) which are positively charged ions and anions such as Bicarbonate (HCO₃), Chloride (CI), Sulfate (SO₄), and Nitrate (NO₃) which are negatively charged ions. An example, of how the cation and anion ions are expressed, are Na⁺ and Cl⁻ respectively. These ions will remain in an aqueous solution as long as their ion concentrations are below their solubility limit. The solubility limit is defined as the ion concentration where no more solid can be dissolved in the water. Furthermore, it is also defined as ratio of the weight of the ions added to 1 kg of water that just saturates the solution. A similar useful definition involving ion concentration is defined as Total Dissolved Solids TDS concentration which is equal to the weight of the ions divided by the total weight of the ions plus the weight of the water in ppm. For most desalination operations, the TDS concentration of the feed water is somewhere between 500 ppm and 35,000 ppm which is that of sea water. Furthermore, the dominant ions present in the feed water of most desalination operations are Na⁺ and Cl⁻.

The ions in the feed water now called the dilute water are transferred into another aqueous solution which is called the concentrate water. In this invention, supersaturated water is defined as having at least one cation and anion ion pairing that is disassociated from a solid in the concentrate water that exceeds the solubility limit. If an ion pairing has an ion concentration at the solubility limit, then any additional like ions transferred into it will create a supersaturated condition for that ion pairing. As long as the ion pairing concentrations are above the solubility limit but below the ion concentration where spontaneous precipitation occurs as discussed in Citation 2 in INFORMATION DISCLOSURE STATEMENT BY APPLICANT Form PTO/SB/08a (01-10) NON-PATENT LITERATURE DOCUMENTS, solids will precipitate out of the aqueous-ion solution over time until the ion pairing concentrations reach the solubility limit for that cation and anion pairing if no more like ions are added to the solution. For example, an aqueous solution of Sodium Sulfate ions exceeding the solubility limit of 281,000 ppm at room temperature will precipitate to solid Sodium Sulfate which is represented in symbol form by (2Na⁺+SO₄⁻⁻ ions→Na₂SO₄ Solid) until the solution is only saturated. So, in this invention as various ions are transferred from the dilute water to the concentrate water, some of them will simply remain disassociated as cations and anions in the aqueous solution while other ion pairings will precipitate out as a solid whenever any ion pairing ion concentration level exceeds the solubility limit for that particular pairing of cations and anions. For many desalination cases of interest, the quantity of Sodium Chloride ions is much greater than other ion types and therefore most of the precipitated solids would be solid Sodium Chloride. However, there will be other ion pairings that will form solids as well.

This invention has three waters called electrolyte, anolyte, and catholyte waters. The electrolyte water is divided into an electrolyte water near the inert anode electrode called anolyte water and an electrolyte water near the inert cathode electrode called catholyte water. After operations on the anolyte and catholyte waters, their chemistry changes and after they are both combined with the remaining electrolyte water forming a water with an altered chemistry that is again called electrolyte water. The electrolyte water is initially formed by dissolving a salt in water. The quantity of salt and the solubility of that salt in water is selected so that the ion-water solution has high conductivity so the electrical resistance of the electrolyte, anolyte, and catholyte waters will be very low. Furthermore, the salt is selected such that under electrolysis, Hydrogen gas is formed at the inert cathode electrode and catholyte water interface and Oxygen gas is formed at the inert anode electrode and anolyte water interface. An example of a salt that will meet these conditions is Sodium Sulfate in concentrations in water of over 200,000 ppm.

Citation 1 in INFORMATION DISCLOSURE STATEMENT BY APPLICANT Form PTO/SB/08a (01-10) under U.S. patents discusses a ZLD desalination process that relies on the method of transferring ions from the feed water into another ionized water solution, which becomes supersaturated and through precipitation, solids are formed. Specifically, it describes a Capacitive Deionization CDI process that removes ions from the ionized feed water and transfers them to another ionized water that can become supersaturated. The supersaturated water is passed through a common precipitation unit where solids precipitate out of the solution and can then be removed. In this cited patent, only an overview description of the CDI process is given and there is no description of the “common” precipitation process. Citation 1 in INFORMATION DISCLOSURE STATEMENT BY APPLICANT Form PTO/SB/08a (01-10) under U.S. PATENT APPLICATION PUBLICATIONS discusses another ZLD process that relies on the method of transferring ions from the feed water into another ionized water solution, which becomes supersaturated and through precipitation, solids are formed. It avoids the power losses in an ordinary electrodialysis process by using many them. Large number of CDI units could be used as well in the process it describes. A precipitation unit is briefly described in that seed crystals can be used to facilitate the precipitation of ions from a supersaturated solution on to them. Although similar to the two publications cited in this paragraph in that they both depend on precipitation to in-part provide the ZLD operation, this invention modifies a single electrodialysis process so it can efficiently and effectively operate when the concentrate ion-water solution is supersaturated. Furthermore, an effective process is developed, which provides very slow motion of the supersaturated ion-water solution through an enhanced clarifier so there is ample time for solids to precipitate solids from the supersaturated ion-water solution before it is reused. The name of this invention is Gated Electrodialysis GED. After describing this GED invention in the Detailed Description of the Invention section of this document, a ZLD standalone desalination example is provided along with its predicted performance when the input feed water has a TDS concentration of 5,000 parts per million ppm. Furthermore, two examples use the GED invention in conjunction with Reverse Osmosis RO to provide ZLD desalination when the input feed water has a TDS of 5,000 ppm. Although not described, the GED invention can operate as a water softener with ZLD properties as well. Multiple large GED units could be used in municipal, commercial, industrial, and agricultural desalination operations and small GED units could be used in residential applications.

### BRIEF SUMMARY OF THE INVENTION

This invention performs Zero Liquid Discharge electrodialysis with applications to water desalination and softening. Since this invention modifies an ordinary electrodialysis system, a brief review of an electrodialysis stack of an electrodialysis system is given. Concentrate and dilute water spacers holding concentrate and dilute water respectively are alternately stacked with alternating cation and anion ion exchange membranes between each spacer. At one end of this stack there is an anolyte spacer that contains an inert anode electrode and anolyte water and at the other end of the stack there is a catholyte spacer that contains an inert cathode electrode and catholyte water. Beyond each of the anolyte and catholyte spacers there are covers which aid in the distribution of the dilute water and finally there are strong metal compression plates on the ends of the previous stack of components which are used to compress the entire assembly together using bolts between the compression plates. This entire assembly is defined as an electrodialysis stack. This invention uses the same form of the electrodialysis stack as the traditional electrodialysis system just described but differs in most of the component construction. Furthermore, this invention differs in the various water distribution systems and the way the entire system operates as well.

Some of the important aspects of the component modifications and operational changes to a conventional electrodialysis system are: (1) modifies the conventional concentrate, anolyte, and catholyte water spacers in the way: (a) the concentrate, anolyte, and catholyte water is distributed to-and-from them, and (b) the dilute water is passed through them, (2) provides a means of mechanically and electrically isolating the concentrate, anolyte, and catholyte water in each individual concentrate, anolyte, and catholyte water spacer respectively so that there is no leakage current with associated power loss during electrodialysis operation, (3) provides a means of changing the concentrate and electrolyte water when the desalination operation is interrupted, (4) desalinates efficiently when the saline concentrate water is supersaturated, (5) insures that there is no cross-water leaks between any of the water types used, (6) provides a way to obtain at least a time of a few tens of hours or more for solids to precipitate from the supersaturated concentrate water located in a reasonably compact enhanced clarifier before it is reused, and (7) separates the solids from the ion-water solution in the enhanced clarifier so that only solid waste is available to be removed.

The concentrate water spacers are made thicker than ordinary concentrate water spacers so that concentrate water can be individually fed into each one from below and retrieved from each one from above. The concentrate water spacer can be created by removing material from a flat rectangular block of non-electrical conducting material, which is on-the-order of twenty to eighty inches on a side and about one and one-quarter-inch thick. The concentrate water spacer is mostly open in its interior except for spaces consisting of back-to-back recessed spaces and back-to-back islands with holes in them within the recessed spaces all near the bottom and the top of the spacer. When the concentrate water spacer is installed in the electrodialysis stack, concentrate water flows: (1) from the bottom of the spacer, (2) through a short distance of empty space, (3) through the lower back-to-back recessed space and around the back-to-back islands located in these recessed spaces, (4) through a large empty space, (5) through the upper back-to-back recessed space, and around the back-to-back islands located in these recessed spaces, (6) through a short distance of empty space, and (7) out the top of the spacer. Dilute water will pass through flanged connectors that are present in the holes in the islands.

The anolyte and catholyte water spacers can be created by removing material from a flat rectangular block of non-electrical conducting material which have the same width and height as the concentrate water spacer with a thickness on-the-order of the concentrate water spacer. The anolyte and catholyte water spacers have: (1) a large recessed space over much of their front side, (2) the same size islands with holes and at the same relative positions as those in the concentrate water spacers and are located near the bottom and the top of the large recessed space, (3) a thin electrode embedded in this large recessed space between the islands, and (4) inlet and outlet water holes in the bottom and top of the spacer respectively. When the anolyte or catholyte water spacer is installed in the electrodialysis stack, anolyte or catholyte water flows: (1) from the bottom of the spacer, (2) over a short distance of recessed space, (3) over the recessed space and around the lower islands with holes, (4) over an electrode embedded in the recessed space, (5) over the recessed space and around the upper islands with holes, (6) over a short distance of recessed space, and (7) out the top of the spacer. Dilute water will pass through flanged connectors that are present in the holes in the islands.

The dilute water spacers can be created by removing material from a flat rectangular block of non-electrical conducting material which have the same width and height as the concentrate water spacer, a thickness of about one-eighth to one-quarter-inch thick, and an interior space that is mostly empty. Dilute water flows: (1) from flanged connectors that perpendicularly protrude into the lower empty space on one side of the dilute water spacer, (2) upward in the mostly empty space, and (3) out flanged connectors that perpendicularly protrude into the upper empty space on other other side of the dilute water spacer. The flanged connectors are part of an adjacent assembly of flanged connectors, ion exchange membranes, and a concentrate, anolyte, or catholyte spacer.

The anion and cation ion exchange membranes have the same height and width as the concentrate water spacer, are about 20 mils thick, and have the same size holes at the same relative locations as the holes in the islands in the concentrate water spacer. Dilute water flows through flanged connectors that are present in the holes of the ion exchange membranes.

The covers are created by removing material from a flat rectangular block of non-electrical conducting material which have the same width and height as the concentrate water spacer with a thickness on-the-order of the concentrate water spacer. The covers have a lower and an upper recessed space. When dilute water enters the bottom of a cover, it flows into the lower recessed space and out of it through flanged connectors located in an anolyte or catholyte spacer that protrude into the lower open space. Furthermore, dilute water enters the upper recessed space from flanged connectors located in an anolyte or catholyte spacer that protrude into the upper recessed space, and flows out of it through the top of the cover.

To ensure that there is no internal cross-water leakage between any of the concentrate, dilute, anolyte, and catholyte water types in the electrodialysis stack, flanged connectors are used. The flanged connectors have a cylindrical shaped outer part that fits into a round hole. Looking at the end of the cylinder, they have holes in their central part and the center hole is threaded. The thin flange portion of the flanged connector extends beyond the cylindrical outer part that fits into holes in spacers, ion exchange membranes, and in some cases gaskets. On each side of a concentrate spacer, a flanged connector is inserted into holes in an ion exchange membrane, gasket, and islands of the concentrate water spacer. A threaded rod screws into the two flanged connectors. When the flanged connector pair is turned, the two flanged connectors press the ion exchange membranes and gaskets firmly against the concentrate water spacer on both sides of it and thus prevents internal water leaks as dilute water passes through the holes in the flanged connectors that are inserted into the islands of the concentrate water spacer. Near each end of the electrodialysis stack, there are multiple components of the electrodialysis stack between the flanged connector pairs.

The dilute water flows (1) into the bottom of a cover, (2) through flanged connectors inserted in the lower holes in various sets of components in the electrodialysis stack, (3) upward in each dilute water spacer, (4) through flanged connectors inserted in the upper holes in various sets of components in the electrodialysis stack, and (5) out the top of the other cover. Because the flanged connectors are pressing various sets of components together at their internal hole locations throughout the assembly, there is no water leaks around the holes in the components in the electrodialysis stack. The concentrate, anolyte, and catholyte waters flows individually through each concentrate, anolyte, or catholyte spacer respectively so there are no cross-water leaks of water between each one. The remaining possible leaks are prevented because the perimeters of all spacers, gaskets, and ion exchange membranes are solid and when they are all compressed together, they obtain a tight seal. Therefore, there is no water leaks or cross-water contamination among the waters in this invention's electrodialysis stack.

The concentrate water flows from a pump located in an enhanced clarifier which serves as a reservoir, through a manifold, and then through a group of check valves or equivalents. These waters then flow from each check valve into the bottom of each concentrate water spacer, through them, and out of their top. Then these waters flow through a group of tubes into a concentrate water container located above the concentrate water spacers where the waters are combined and then by gravity, flow back to the enhanced clarifier. There is one check valve and one tube for each concentrate water spacer. The check valves have the property of allowing the concentrate waters to flow toward the concentrate water spacers when the pump is on but prevents concentrate waters to flow backward as well as does not allow electrical current through the valves when the pump is off. The concentrate water container has the property of combining the waters from the tubes and outputting these combined waters to the enhanced clarifier when the pump is on. But when the pump is off, the concentrate water container's property is that there is concentrate water trapped and stationary in the tubes and associated concentrate water spacers due to the closed check valves and there is no physical and electrical connection between the outputs of the tubes in the concentrate water container. Consequently, since there is no electrical connection below and above each the individual concentrate water spacer, there is no power lost in the concentrate water distribution system when there is electrical power applied to the electrodes resulting in desalination operation for a period of a few hours. But when the desalination process is interrupted and the concentrate water pump is turned on for a period of a few minutes, the concentrate water can completely circulate through the entire concentrate water distribution system. The electrolyte water distribution system is of the same form as the concentrate water distribution system and consequently there can be no leakage current flow and power loss in the electrolyte water distribution system that contains the anolyte and catholyte water spacers during desalination operation but allows the electrolyte water to circulate when the desalination process is interrupted. The dilute water is always circulated and because of its conventional distribution system's nature, there is always negligible power loss in the dilute water distribution system.

Ideally this invention creates solid waste using two facts which are: (1) given enough time, supersaturated water, that is below the concentration level where spontaneous precipitation occurs, will precipitate out solids until a saturation condition is reached and (2) given enough time, precipitated solids will form and grow in the supersaturated ion-water solution and eventually drift to the bottom of a container and/or grow on like ion seed crystals suspended in the supersaturated ion-water solution. By construction in this invention as described earlier, the concentrate waters are held stationary in the concentrate water spacers and they are electrically and mechanically isolated from one another while desalination is being performed for a period of at least one hour or even more. There is only on the order of 35 gallons of concentrate water held in all the concentrate water spacers for the examples given in this invention disclosure. Now every hour or so, this old now supersaturated saline water, which possibly has some already precipitated solids in it, is removed from the concentrate water spacers and sent to the enhanced clarifier's input while new nearly saturated saline water is brought into the concentrate spacers from the enhanced clarifier's output. The average volume rate of concentrate water moving through the enhanced clarifier then is 35 gallons per hour (35 gallons divided by 1 hour). If the enhanced clarifier has a volume of 700 gallons, then it would take 20 hours for the concentrate water to move from the enhanced clarifier's input to its output. As the supersaturated water slowly drifts from the enhanced clarifier's input to the clarifier's output over the time frame of 20 hours, solids precipitate out of the supersaturated solution and the precipitated solids either form, grow, and slowly drift to the bottom of the enhanced clarifier and/or grow on seed crystals of the same chemical composition as the precipitating ions or both where in either case the solids can then be removed. This invention provides the very slow movement of supersaturated concentrate water so the solids can form, separate from the water, and be removed from the supersaturated concentrate water using reasonably compact enhanced clarifiers. The enhanced clarifier contains means of enhancing the precipitation of solids from the ion-water solution. It should be noted that some ions entering the concentrate water will simply add to the concentration levels of those ions in the water while other ions will form supersaturated ion pairings that exceed their solubility limit and will precipitate out solids from the ionized water solution.

### BRIEF DESCRIPTION OF THE SEVERAL VIEWS OF THE DRAWING(S)

FIG. 1: Block diagram of the Invention's Gated Electrodialysis Unit with its associated additional ancillary components

FIG. 2: Schematic diagram of the Gated Electrodialysis Unit showing the ion flow and the concentrate water flow but excluding the dilute, electrolyte, anolyte, catholyte water's flow

FIG. 3: Schematic diagram of the Gated Electrodialysis Unit showing the ion flow and the electrolyte, anolyte, catholyte water's flow but excluding the dilute and concentrate water flow

FIG. 4: Block diagram of the Power Controller operations that control the power to the constant power Direct Current DC power supply and pumps

FIG. 5: Illustration of an Ideal Clarifier and Pump operation

FIG. 6: Illustration of a Concentrate Water Enhanced Clarifier and Pump operation

FIG. 7: Illustration of the Concentrate Water Spacers

FIG. 8: Illustration of the Dilute Water Spacers

FIG. 9: Illustration of the Cation Ion Exchange Membranes

FIG. 10: Illustration of the Anion Ion Exchange Membranes

FIG. 11: Illustration of the front view of the Anolyte and Catholyte Water Spacers

FIG. 12: Illustration of the rear view of the Anolyte and Catholyte Water Spacers

FIG. 13: Illustration of the front view of the Covers

FIG. 14: Illustration of the rear view of the Covers

FIG. 15: Illustration of the Compression Plates

FIG. 16: Exploded view showing two Flanged Connectors and the Threaded Rod connecting them

FIG. 17: Elongated Flanged Connectors which are used in place of the Flanged Connectors near the anode end of the Electrodialysis Stack

FIG. 18: Illustration of the Concentrate, Anolyte, and Catholyte Water Spacer's Gaskets

FIG. 19: Illustration of the Dilute Water Spacer's Gaskets

FIG. 20: Illustration of the Cover's Gaskets

FIG. 21: Illustration of the Flanged Connector's Gaskets

FIG. 22: Exploded view of how the Dilute Water Spacers, Anion Ion Exchange Membranes, Concentrate Water Spacers, Cation Ion Exchange Membranes, and associated gaskets are assembled from left to right in the central region of the Electrodialysis Stack, but not showing the Flanged Connector assemblies

FIG. 23: Exploded view of how the Dilute Water Spacer, Cation Ion Exchange Membrane, Catholyte Water Spacer, Cover, Compression Plate and associated gaskets are assembled from right to left near the Cathode end of the Electrodialysis Stack, but not showing the Flanged Connector assemblies

FIG. 24: Exploded view of how the Anion Ion Exchange Membrane, Concentrate Water Spacer, Cation Ion Exchange Membrane, Anolyte Water Spacer, Cover, Compression Plate, and associated gaskets are assembled from left to right near the Anode end of the Electrodialysis Stack, but not showing the Flanged Connector assemblies

FIG. 25: Exploded partial view of how the Flanged Connectors and their associated Threaded Rod are used to press the Cation and Anion Ion Exchange Membranes along with associated gaskets against the Concentrate Water Spacer

FIG. 26: Exploded partial view of how the Flanged Connectors and their associated Threaded Rod are used to press the Cation Ion Exchange Membrane along with associated gaskets against the Catholyte Water Spacer near the Cathode end of the electrodialysis stack

FIG. 27: Exploded partial view of how the Elongated Flanged Connectors, Flanged Connectors and their associated Threaded Rod are used to press the Cation and Anion Ion Exchange Membranes along with associated gaskets against both the Concentrate and Anolyte Water Spacers near the Anode end of the electrodialysis stack

FIG. 28: Concentrate Water Manifold and Check Valves to feed concentrate water to four Concentrate Water Spacers from the Concentrate Water Clarifier and Pump

FIG. 29: Electrolyte Water Manifold and Check Valves to feed electrolyte water to Anolyte and Catholyte Water Spacers from the Electrolyte Water Reservoir and Pump

FIG. 30: Concentrate Water Container with tubes from four Concentrate Water Spacers extending through the bottom of the Concentrate Water Container plus its drain back to the Concentrate Water Clarifier and Pump

FIG. 31: Electrolyte Water Container with tubes from the Anolyte and Catholyte Water Spacers extending through the bottom of the Electrolyte Water Container plus its drain back to the Electrolyte Water Reservoir and Pump

FIG. 32: Side view of the assembled Electrodialysis Stack containing the Concentrate Water Manifold, Check Valves, and Concentrate Water Container but not the Electrolyte Water Manifold, Check Valves, and Electrolyte Water Container

FIG. 33: Side view of the assembled Electrodialysis Stack containing the Electrolyte Water Manifold, Check Valves, and Electrolyte Water Container but not the Concentrate Water Manifold, Check Valves, and Concentrate Water Container

FIG. 34: Block Diagram of the Constant Power Direct Current DC Power Supply

FIG. 35: Flow diagram of the operations performed in the performance analysis of the examples

FIG. 36: Flow diagram of the operations performed in the performance analysis of the examples continued

FIG. 37: Flow diagram of the operations performed in the performance analysis of the examples continued

FIG. 38: Flow diagram of the operations performed in the performance analysis of the examples continued

FIG. 39: Current versus time for the Invention's Stand-Alone Desalination Example

FIG. 40: Voltage versus time for the Invention's Stand-Alone Desalination Example

FIG. 41: Total Dissolved Solids TDS concentration versus time for the Invention's Stand-Alone Desalination Example

FIG. 42: Energy Used versus time for the Invention's Stand-Alone Desalination Example

FIG. 43: Block diagram of the operations associated with the Invention's Gated Electrodialysis GED Unit used in conjunction with a Reverse Osmosis RO Unit for Example 2

FIG. 44: Current versus time for the Invention's Gated Electrodialysis GED Unit used in conjunction with Reverse Osmosis RO desalination for Example 2

FIG. 45: Voltage versus time for the Invention's Gated Electrodialysis GED Unit used in conjunction with Reverse Osmosis RO desalination for Example 2

FIG. 46: Total Dissolved Solids TDS concentration versus time for the Invention's Gated Electrodialysis GED Unit used in conjunction with Reverse Osmosis RO desalination for Example 2

FIG. 47: Energy Used versus time for the Invention's Gated Electrodialysis GED Unit used in conjunction with Reverse Osmosis RO desalination for Example 2

FIG. 48: Block diagram of the operations associated with the Invention's Gated Electrodialysis GED Unit used in conjunction with a Reverse Osmosis RO Unit for Example 3

FIG. 49: Schematic diagram of an Alternate Gated Electrodialysis Unit excluding the concentrate, dilute, electrolyte, anolyte, catholyte water's flow

### DETAILED DESCRIPTION OF THE INVENTION

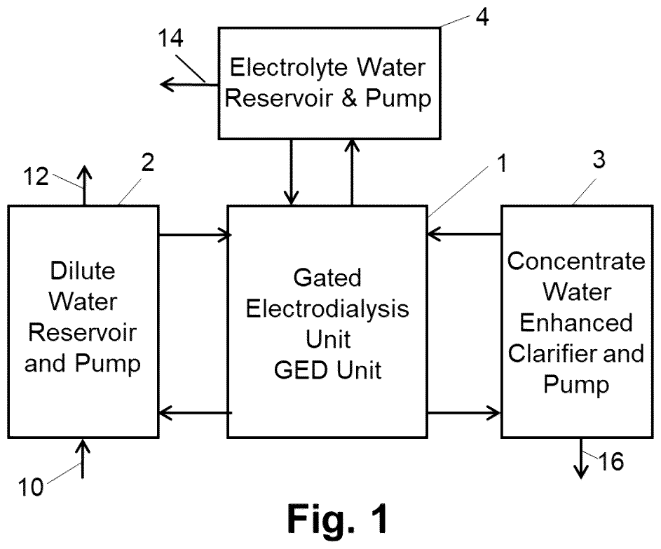

This invention modifies the structure of a common electrodialysis ED/EDR unit as described in Citation 3 in INFORMATION DISCLOSURE STATEMENT BY APPLICANT Form PTO/SB/08a (01-10) under NON-PATENT LITERATURE DOCUMENTS. This modified common electrodialysis unit will be called Gated Electrodialysis GED unit. Its unique functions are: (1) capable of efficiently transferring ions from the dilute water to the concentrate water when the concentrate water is supersaturated with at least one ion pairing type but below concentrations where spontaneous precipitation occurs while the dilute water can have any TDS concentration, (2) provide sufficient time for solids to precipitate from the concentrate supersaturated ion-water solution in a reasonably compact enhanced clarifier, and (3) the only waste is a solid material. The operation of the GED in a Stand-Alone configuration is illustrated in the block diagram of FIG. 1. Source feed water 10 to be desalinated is brought into the Dilute Water Reservoir and Pump 2. The dilute water is circulated between the Dilute Water Reservoir and Pump 2 and the GED Unit 1. The GED Unit 1 consists of a modified electrodialysis stack, external concentrate and electrolyte water distribution systems, and electrical equipment all in which will be discussed later. Concentrate water is also circulated between the Concentrate Water Enhanced Clarifier and Pump 3 and the GED Unit 1. Electrolyte water is also circulated between the Electrolyte Water Reservoir & Pump 4 and the GED Unit 1. Hydrogen and Oxygen gases are vented 14 from the Electrolyte Water Reservoir & Pump 4. Precipitated solids 16 are periodically removed from the Concentrate Water Enhanced Clarifier and Pump 3. When the ions in the dilute water have been depleted to the desired TDS concentration level in the Dilute Water Reservoir and Pump 2, the dilute water in the Dilute Water Reservoir and Pump 2 is removed through 12 and new feed water 10 to be deionized is transferred to the Dilute Water Reservoir and Pump 2.

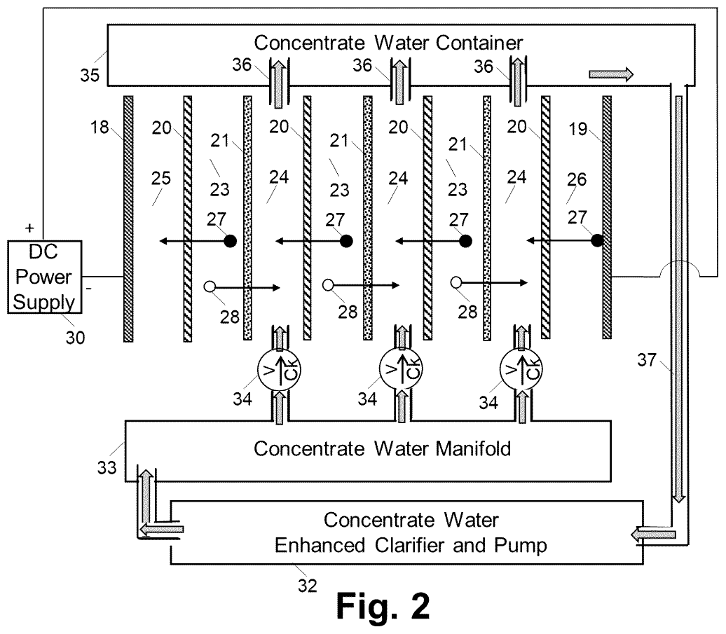

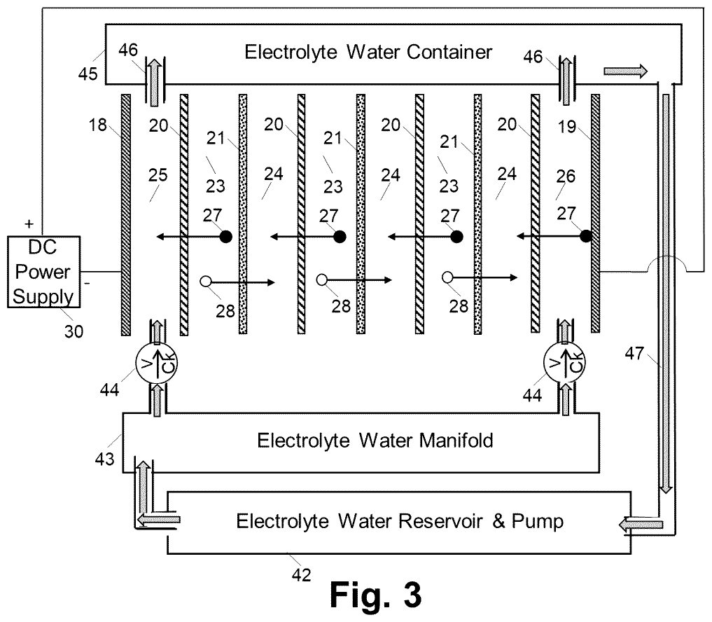

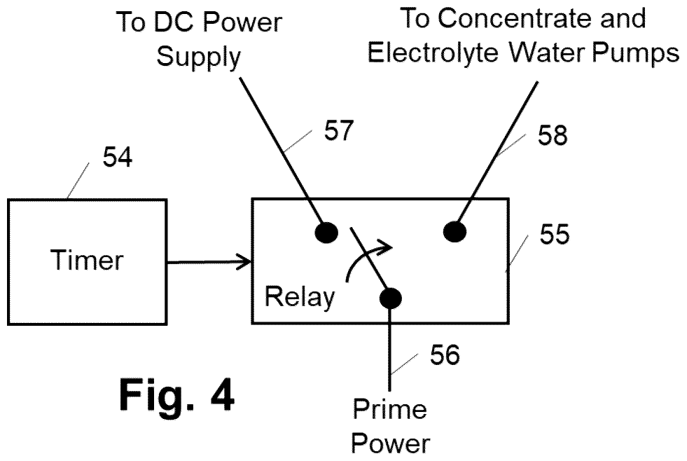

FIGS. 2 and 3 illustrates the internal operations of the GED invention. FIGS. 2 and 3 only differ in that FIG. 2 illustrates the GED operation including the concentrate water distribution system but excluding the electrolyte water distribution system while FIG. 3 illustrates the electrolyte water distribution system but excludes the concentrate water distribution system. The dilute water distribution system is internal, not shown, and is discussed later. First the common portions of FIGS. 2 and 3 are discussed together. The left inert cathode electrode 18 is attached to the negative terminal of a Direct Current DC Power Supply 30 which can gated on and off with a Power Controller described later using FIG. 4. The right inert anode electrode 19 is attached to the positive terminal of the DC Power Supply 30. Next to the inert cathode and anode electrodes 18 and 19, there are spaces 25 and 26 for the catholyte and anolyte waters to flow respectively. Adjacent to the catholyte water space 25 on the left is a Cation Ion Exchange Membrane 20 followed by a dilute water space 23. Next to this first dilute water space 23 on the left, there is an Anion Ion Exchange Membrane 21 followed by a concentrate water space 24. The sequence of Cation Ion Exchange Membranes 20, dilute water spaces 23, Anion Ion Exchange Membranes 21, concentrate water space 24 is repeated from left to right until the Cation Ion Exchange Membrane 20 nearest the anolyte water space 26 nearest the right anode electrode 19 is reached. Given the DC Power Supply 30 is gated on, the cations 27 flow from right to left from waters on the right side of the Cation Ion Exchange Membranes 20 to waters on the left side of it. The anions 28 flow from left to right from waters on the left side of the Anion Ion Exchange Membrane 21 to waters on the right side of it. The anions cannot flow through the Cation Ion Exchange Membrane and the cations cannot flow through the Anion Ion Exchange Membrane. Thus, ions flow out of dilute water spaces 23 and into the concentrate water spaces 24 except at each end where on the right cations flow out of the anolyte water space 26 into the most right concentrate water space 24 and on the left cations flow from the most left dilute water space 23 into the catholyte water spaces 25. Consequently, this process is called desalination because the ions are being transferred from the dilute water spaces to the concentrate water spaces.

Next the concentrate water distribution system portion shown in FIG. 2 is discussed. During the time the GED is not performing desalination, the concentrate water is transferred from the Concentrate Water Enhanced Clarifier and Pump 32 to the Concentrate Water Manifold 33. From there it is vertically transferred from the multiple ports of the Concentrate Water Manifold 33 through multiple corresponding Check Valves 34 to the bottom of the concentrate water spaces 24. An alternative to the Check Valves 34 is normally closed electrically activated valves that open when the pump in the Concentrate Water Enhanced Clarifier and Pump 32 is activated. From the top of the multiple concentrate water spaces 24, the concentrate water is vertically passed through corresponding Tubes 36 into the Concentrate Water Container 35. The Tubes 36 extend vertically part way into the Concentrate Water Container 35 so that the concentrate water flows vertically from the Tubes 36 before falling back down in the Concentrate Water Container's 35 floor due to gravity where it then drains through Tube 37 back into the Concentrate Water Enhanced Clarifier and Pump 32. Now, when the pump in the Concentrate Water Enhanced Clarifier and Pump 32 stops and desalination is being performed, the Check Valves 34 close trapping concentrate water in the concentrate water spaces 24. Furthermore, since the Check Valves 34 are constructed with plastic parts, there is no physical or electrical connection between the concentrate waters below the Check Valves 34 and the above concentrate water in the concentrate water spaces 24. In addition, when the pump in the Concentrate Water Enhanced Clarifier and Pump 32 stops and desalination is being performed, the concentrate water stops flowing in the Tubes 36, water drains out of the Concentrate Water Container 35, and the result is that there is no physical or electrical connection between the concentrate waters above the concentrate water spaces 24. Now since there are no physical or electrical connections between the concentrate waters below and above the concentrate water spaces, which are independent, there is no leakage current through the concentrate water distribution system during desalination operation while still allowing for the concentrate water in the concentrate water spaces 24 to be periodically removed and replaced when the desalination process is interrupted and the pump in Concentrate Water Enhanced Clarifier and Pump 32 is turned on. The arrangement of the concentrate water flow shown in FIG. 2, that prevents electrical current flow in the concentrate water distribution system during desalination operation, overcomes the significant loss in leakage current in the concentrate water distribution system that common electrodialysis systems would exhibit when the concentrate water is supersaturated but below the ion concentrations in which spontaneous precipitation occurs and the dilute water has very low TDS concentrations even as low as 50 ppm.

Next the electrolyte water distribution system portion of the GED unit shown in FIG. 3, which is similar to the concentrate water distribution system shown in FIG. 2, is discussed. Electrolyte Water Reservoir & Pump 42 outputs electrolyte water to the Electrolyte Water Manifold 43. From there it is vertically transferred from the two ports of the Electrolyte Water Manifold 43 through two corresponding Check Valves 44 to the bottom of the anolyte and catholyte water spaces 26 and 25 respectively. By convention, the electrolyte water near the anode is defined as anolyte water and the electrolyte water near the cathode is defined as catholyte water. An alternative to the Check Valves 44 is normally closed electrically activated valves that open when the pump in the Electrolyte Water Reservoir & Pump 42 is activated. From the top of the anolyte and catholyte water spaces 26 and 25 respectively, the anolyte and catholyte waters are vertically passed through corresponding Tubes 46 into the Electrolyte Water Container 45. The Tubes 46 extend vertically part way into the Electrolyte Water Container 45 so that the anolyte and catholyte waters flows vertically from the Tubes 46 before falling back down in the Electrolyte Water Container's 45 floor due to gravity where it then drains through Tube 47 back into the Electrolyte Water Reservoir & Pump's 42. After the anolyte and catholyte waters have been combined in the Electrolyte Water Container 45, the water is again called electrolyte water. Now, when the pump in the Electrolyte Water Reservoir & Pump 42 stops and desalination is being performed, the Check Valves 44 close trapping anolyte and catholyte water in the anolyte and catholyte water spaces 26 and 25 respectively. Furthermore, since the Check Valves 44 are constructed with plastic parts, there is no physical or electrical connection between the anolyte and catholyte waters below the Check Valves 44 and the anolyte and catholyte water spaces 26 and 25 respectively. In addition, when the pump in the Electrolyte Water Reservoir & Pump 42 stops and desalination is being performed, the anolyte and catholyte water stops flowing in the Tubes 46 and water drains out of the Electrolyte Water Container's 45 where the result is that there is no physical or electrical connection between the anolyte and catholyte water spaces 26 and 25 respectively. Now since there are no physical or electrical connections between the anolyte and catholyte waters below and above the anolyte and catholyte water spaces, which are independent, there is no leakage current through the electrolyte water distribution system during desalination operation while still allowing for the anolyte and catholyte water in the anolyte and catholyte spaces 26 and 25 to be periodically removed and replaced when the desalination process is interrupted and the pump in Electrolyte Water Reservoir & Pump 42 is turned on. The arrangement of the electrolyte water flow shown in FIG. 3 eliminates any possible leakage current in it. During desalination operation, Oxygen gas is formed at the anolyte water and inert anode interface and Hydrogen gas is formed at the catholyte water and inert cathode interface. The Oxygen and Hydrogen gases are vented to the atmosphere in the Electrolyte Water Container 45. Furthermore, during desalination operation the anolyte water becomes basic and the catholyte water becomes acidic but after they are combined in the Electrolyte Water Container 45 the resulting electrolyte water becomes neutral in pH.

Digressing momentarily, the reason why the conventional ED systems are modified to eliminate any leakage current when the concentrate water is supersaturated and highly conductive is provided in the following discussion. First, note the equation for electrical resistance R equals ρ d/A where ρ is the resistivity, d distance traveled, and A the cross-sectional area. For now excluding the anolyte and catholyte waters, there are three paths for the current to follow in the electrodialysis stack: (1) primary path from anode to cathode through the dilute and concentrate spaces and anion and cation ion exchange membranes with cross-sectional area Aₚ, (2) secondary path through the concentrate water feed system to the concentrate water spaces with cross-sectional area Aₛ, and (3) secondary path through the dilute water feed system to the dilute water spaces with cross-sectional area Aₛ. The cross-sectional area Aₚ>>cross-sectional area Aₛ and if the resistivities of both the dilute and concentrate water are not too different which is the case in most common electrodialysis desalination systems and the distance d is about the same, the electrical resistance in the secondary paths is much greater than the electrical resistance in the primary path and there is little leakage current. But in our case, the resistivity is much less in the supersaturated concentrate water relative to the dilute water which can make the electrical resistance in the secondary concentrate water distribution system comparable to or even less than that in the primary path and consequently there can be significant loss due to leakage current, that does no useful work, in the secondary concentrate water distribution system. So, this invention uses the arrangement shown in FIG. 2 to eliminate any leakage current in the concentrate water distribution system. The resistance in the dilute water distribution system is high relative to the resistance through the electrodialysis stack because of the relatively small cross-sectional areas of the paths in the dilute water distribution system and the low conductivity of the dilute water and therefore their leakage currents are negligible. Depending on how the electrolyte water is distributed in conventional ED systems, there can be significant leakage current there as well. However, this invention eliminates any possible leakage current in the electrolyte distribution system.

FIG. 4 illustrates the Power Controller operations for the GED invention that is required in the processes described in FIGS. 2 and 3. The Timer 54 has two states. The OFF-state time interval is adjusted such that there is just enough time for: (1) the concentrate water in the concentrate water spaces to be sent to the Concentrate Water Enhanced Clarifier and Pump 32 input and for the concentrate water in the Concentrate Water Enhanced Clarifier and Pump 32 output to be sent back to the concentrate water spaces 24 as shown in FIGS. 2 and (2) anolyte and catholyte water in the anolyte and catholyte water spaces 26 and 25 respectively to be sent to the Electrolyte Water Reservoir & Pump 42 input and for the electrolyte water in the Electrolyte Water Reservoir & Pump 42 output to be sent back to the anolyte and catholyte water spaces 26 and 25 as shown in FIG. 3. During the ON-state, the concentrate, anolyte, and catholyte waters in the concentrate, anolyte, and catholyte water spaces are stationary and isolated and the concentrate water is being supersaturated due to the desalination operation, but before its TDS concentration level is reached where spontaneous precipitation would occur. So, during the ON-state, the Timer 54 sets the Relay 55 to transfer the Prime Power from location 56 to location 57 which is attached to the DC Power Supply 30 in FIG. 2 or 3 so that desalination takes place while there is no power supplied to location 58 which is attached to the pumps in the Concentrate Water Enhanced Clarifier and Pump 32 in FIG. 2 and the Electrolyte Water Reservoir & Pump 42 in FIG. 3. During the OFF-state of the Timer 54, the Relay 55 transfers the Prime Power from location 56 to location 58 which is attached to the pumps in the Concentrate Water Enhanced Clarifier and Pump 32 in FIG. 2 and the Electrolyte Water Reservoir & Pump 42 in FIG. 3 and not attached to location 57 of the DC Power Supply 30 shown in FIG. 2 or 3. The dilute water pump is always on. The OFF-state time interval would be typically on the order of a few minutes and the ON-state time interval would typically be on the order of a few hours. This gating of components of the invention on-and-off while performing electrodialysis is where the GED invention received its name

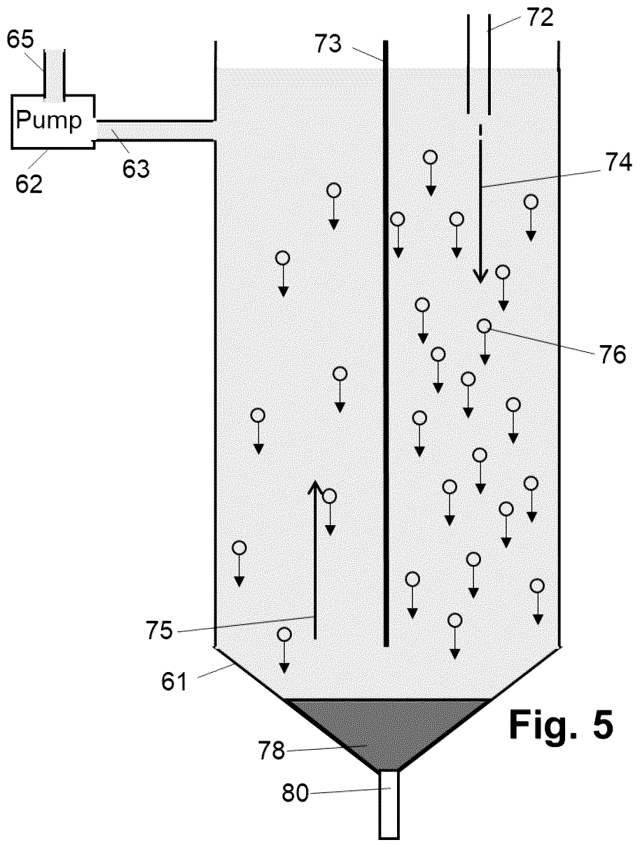

A reason beyond that of eliminating large power losses for modifying the ordinary common ED/EDR desalination system is that the concentrate water flow in the Enhanced Clarifier is greatly slowed down so as to allow time for precipitation of solids and the separation of these solids from the supersaturated ion-water solution. Precipitation of solids within a supersaturated solution is fairly complex and is subsequently discussed. For now, an ideal way the clarifier might operate is for ions to simply precipitate out of the supersaturated ion-water solution forming a solid and drift to the floor of the Ideal Clarifier and Pump as described next. The Ideal Clarifier and Pump shown in FIG. 5 in-part consists of a large tank 61 of concentrate water with a divider 73. The divider 73 vertically divides the concentrate water in the tank 61 into two equal parts, but the divider 73 is open near the bottom of the tank. The bottom of the tank is constructed as a funnel and receives as well as holds precipitating solids 78. The supersaturated concentrate water from its entry point from Tube 72 moves very slowly downward 74 on the right side of the tank, across the tank near the bottom, upward 75 on the left side of the tank, to the exit point 63, through the pump 62, and out to the Concentrate Water Manifold through 65. During this time, solids 76 can precipitate from the supersaturated water and either remain suspended in the water or slowly drift to the floor of the tank 61 where the solids 78 are contained on the bottom of the tank 61. There is a chute and trap door 80 to periodically remove the solids from the bottom of the tank 61. An example operation, that is commensurate with the performance examples provided later, is given as follows. The total concentrate water held in all of the concentrate water spaces is 35 gallons. Once an hour the 35 gallons of supersaturated concentrate water from the Concentrate Water Container is sent to the input 72 of the tank 61 and new concentrate water from the tank's 61 output 63 is sent back to the Concentrate Water Manifold. Next assume the tank holding capacity is 700 gallons. Then it would take 20 hours (700 gallons/35 gallons per hour) for the water that entered 72 to arrive at the exit point 63. When the ion concentration of one or more ion pairings exceeds their solubility limit in the concentrate water, there should be ample time for the solids to precipitate from the supersaturated water and drift to the bottom of the Ideal Clarifier. The dimensions of a 700-gallon tank would be on the order of 3½ feet in diameter and 10 feet tall.

Before discussing the precipitation of solids in the supersaturated ion-water solution more closely, a similar but different common precipitation event involving rain is discussed. Gaseous transparent water vapor as a solute can be distributed throughout the air which is the solvent. The solute water vapor can become supersaturated in the air solution and precipitate out very small water droplets which are suspended in the air to form clouds. However, theory suggests that there are microscopic particles available in the air for the supersaturated water vapor to precipitate onto or in other words condense onto and without the microscopic particles it may be more difficult for the supersaturated water vapor to precipitate into a liquid. Anyhow, once tiny water droplets form, they will then grow by further precipitation of the saturated water vapor onto the water droplets and with collisions with other water droplets until they are heavy enough to fall to the ground due to gravity as rain. However, it is not always clear how the rain starts to fall because supersaturated air with water vapor can exist at least for a while along with tiny water droplets suspended in the form of a cloud and yet no rain is falling.

The precipitation of solids from an ion-water solution is thought to be similar to rain. There are microscopic particles everywhere including some suspended in the aqueous solution. Theory suggests that the precipitation of solids from a supersaturated water containing ions begin and grow on these microscopic particles much in the same manner as that what occurs in rain. Assuming this is true, the Ideal Clarifier previously described will separate the precipitating solids from the supersaturated ion-water solutions. Furthermore, if additional microscopic particles having the same pair wise chemical compositions as those solids that would be precipitating out of the ion-water solution are added to the solution, then the rate of precipitating solids should increase.

An alternative to the process of precipitating solids from the ion-water solution just given is that related to crystal growing. Macroscopic seed crystals, that are large enough so that they would sink to the bottom of a container if not supported, are suspended in a supersaturated ion-water solution. Since the rate of ion disassociation of ions is less that the rate of ion association of ions meaning precipitation on to a crystal in a supersaturated ion-water solution, the seed crystals will grow in size. This process avoids the problems associated with initiating crystal growth by itself or on micro size crystals as discussed previously because the macro sized seed crystals are already large enough to drift to the bottom of the container. So, these facts suggest that the Clarifier could be constructed to hold multiple macro sized seed crystals that would be supported in the Clarifier by some means such as a perforated tray or netting. Furthermore, these crystals should contain the same chemical composition as the ion pairings that will become supersaturated in the supersaturated ion-water solution so crystal growth is most advantageous. Because the crystal growth is a fairly slow process which could be at a rate of one millimeter per hour, the Clarifier as previously described with the addition of seed crystals does provide a significantly long time for the crystal growth to occur and the concentrate water to be reduced in concentration levels before it is reused at the output of the Clarifier.

Before proceeding further, a number of know properties of precipitation are discussed. First, pure undisturbed supersaturated ion-water solution can remain totally in liquid form for long periods of time having no solids precipitated out even though its chemistry is unstable. However, precipitation of solids can occur once disturbed in some manner. Two previous means of disturbing the supersaturated ion-water solution so as to create precipitation have already been mentioned. One is placing microscopic particles in the solution and the other by supporting macro sized crystals in the solution. The crystal growth rate of the crystal depends in part on the concentration of ions above the saturation concentration level. The more supersaturated the solution is, the faster that the crystals will grow. It is well known that precipitation is more prominent on rough or scratched surfaces, so the addition of panels containing scratched surfaces in the Clarifier will support improved precipitation of solids from the supersaturated ion-water solution. Sometime pH of the water can affect the precipitation. It is thought that disturbances such as vibrations and/or stirring can also affect the precipitation rate. Another process that can affect precipitation is to add a chemical to the supersaturated ion-solution which can result in precipitation of a solid formed by pairing one ion from the ion-water solution with one ion from the added chemical so as to form a solid in the same way that lime-softening works. Since the solubility limit in many ion pairings cases is temperature dependent, precipitation may be slowed down or improved by changing the temperature of the supersaturated ion-water solution. For example, the concentrate water could be heated entering the concentrate water spaces and cooled in the Clarifier to promote to promote precipitation. Another process that is used in municipal water treatment plants is coagulation which adds highly charged molecules into water to destabilize the static charges on the suspended particles so they will clump together better and become heavy enough so they will drift to the bottom of a tank.

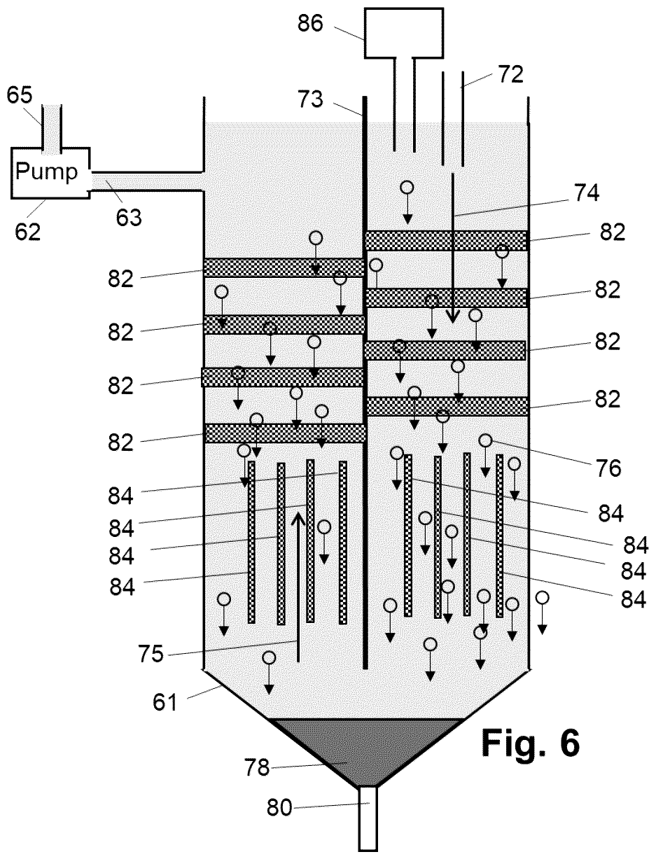

Using the information on precipitation previously discussed, a Concentrate Water Enhanced Clarifier and Pump can be built as shown in FIG. 6. Parts of it is the same as the Ideal Clarifier and Pump described with aid of FIG. 5 and that description is first repeated. The Concentrate Water Enhanced Clarifier and Pump consists of a large tank 61 of concentrate water with a divider 73 as shown in FIG. 6. The divider 73 vertically divides the concentrate water in the tank 61 into two equal parts, but the divider 73 is open near the bottom of the tank. The bottom of the tank is constructed as a funnel and receives as well as holds precipitating solids 78. The supersaturated concentrate water from its entry point from Tube 72 moves very slowly downward 74 on the right side of the tank, across the tank near the bottom, upward 75 on the left side of the tank, to the exit point 63, through the pump 62, and out to the Concentrate Water Manifold through 65. During this time, solids 76 can precipitate from the supersaturated water and either remain suspended in the water or slowly drift to the floor of the tank 61 where the solids 78 are contained on the bottom of the tank 61. There is a chute and trap door 80 to periodically remove the solids from the bottom of the tank 61. Perforated Trays 82, that contain macro sized crystals consisting of various chemistries of ion-parings that will be precipitating on them, are inserted in the concentrate water paths of movement. After the crystals grow in size and weight due to precipitation, they can be removed as solids and new trays containing the same type of macro sized crystals replaces them. Thin Panels 84 that have rough and scratched surfaces are placed in the concentrate water paths to enhance crystal growth. A Box 86 or boxes provide a means of emptying chemicals into the concentrate water held in the tank 61. Box 86 is placed above the tank 61. Some of the types of chemicals that can be placed in the box or boxes are: (1) microscopic particles with the same ion pairing makeups as the ions that will precipitate from the supersaturated ion-water solution, (2) alter what ion parings precipitate, (3) alter the water's pH, and (4) alter the static charge on the crystals as well as alter their clumping capability. Other factors which enhance the precipitation into solids are temperature changes, and motion such as stirring and vibration which are not shown.

Before describing the invention in any more detail, an ideal and over simplified example of the concentrations and volume of ionized waters at various locations in FIG. 1 are given as follows. Assume 1,000 gallons of an aqueous Sodium Chloride solution having an initial Total Dissolved Solids TDS concentration of 5,000 ppm is contained in the Dilute Water Reservoir and Pump 2. This water is circulated through the GED until the TDS concentration is reduced to 100 ppm. At the same time, an aqueous Sodium Chloride solution having a saturated TDS concentration of 265,000 ppm, which is contained in the Concentrate Water Enhanced Clarifier and Pump 3, is placed in the concentrate water spaces of the GED unit 1 and the electrodialysis process is performed. The Sodium Chloride ions in the dilute water pass into the concentrate water which is contained and stationary in the concentrate water spaces. This concentrate water then becomes supersaturated but below the TDS concentration level that spontaneous precipitation occurs. Every hour for the example given, the supersaturated water is sent to the Concentrate Water Enhanced Clarifier and Pump 3 from the GED unit and new concentrate water is fed into the GED unit. After sufficient time has passed, Sodium Chloride salt ions precipitate out of the supersaturated concentrate water forming a solid and drift to the floor and/or grow on macro sized suspended crystals in the Concentrate Water Enhanced Clarifier and Pump 3. The weight of the Sodium Chloride solid removed from the Concentrate Water Enhanced Clarifier and Pump 3 for this example is approximately computed using the weight of one gallon of pure water of 3.78 kg/gal, approximate relative density of low concentrations salt water of 1.0, 1,000 gallons of water, and change in TDS concentration by the formula ((5,000 ppm−100 ppm)×1,000 gallons×1.0×3.78 kg/gal to be equal to 19 kg. After precipitation of solids, the now saturated aqueous Sodium Chloride solution with a TDS concentration of 265,000 ppm remain in the Concentrate Water Enhanced Clarifier and Pump 3 and is made available to be used again at the output of the Clarifier.

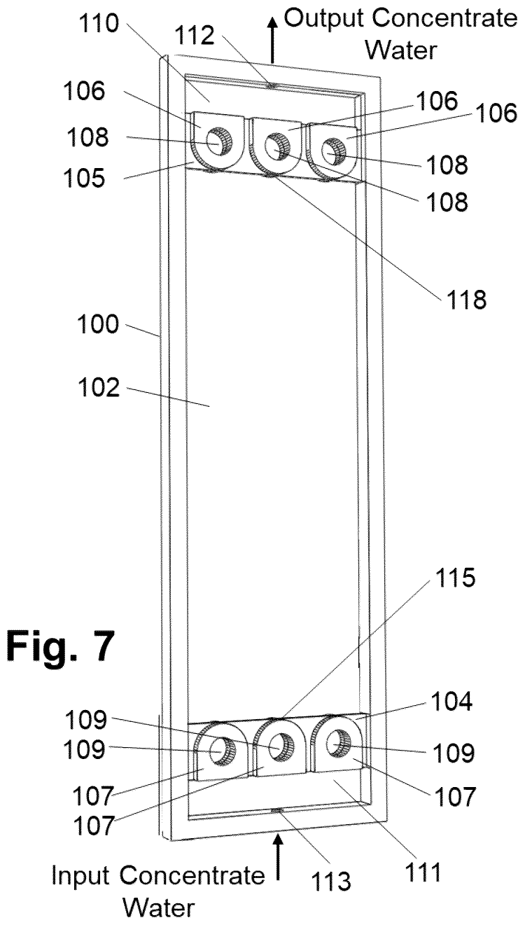

The structure of the invention's GED, which is similar to that of the traditional ED/EDR, is next described through an example configuration. The dimensions given are representative dimensions but larger or smaller dimensions are possible. The front view of the Concentrate Water Spacer 100 is illustrated in FIG. 7. The back view would look identical to the front view. This description of the Concentrate Water Spacer begins by assuming there is a flat rectangular non-electrical conducting block of material like plastic of which polypropylene is an example. Then material is removed from it to form (1) Empty Space Regions, (2) Recessed Spaces Leaving Islands Regions, and (3) Holes. It has outer dimensions of 42 inches tall, 13 inches wide, and about 1¼ inch thick. In FIG. 7, material is removed from the original flat rectangular block to form a Small Empty Space 110 near the top and a Small Empty Space 111 near the bottom of the Concentrate Water Spacer 100. There is a threaded hole 113, that can accept a water fitting, at the bottom of the Concentrate Water Spacer for concentrate water to enter the Concentrate Water Spacer 100. There is a threaded hole 112, that can accept a water fitting, at the top of the Concentrate Water Spacer for concentrate water to leave the Concentrate Water Spacer 100. By removing material from the original flat rectangular block, two Recessed Spaces Leaving Islands Regions 115 and 118 are created on the front and two identical Recessed Spaces Leaving Islands Regions, that are not shown, on the back side which are directly behind the two front Recessed Spaces Leaving Islands Regions 115 and 118. The bottom front side of the Recessed Spaces Leaving Islands Region 115 is composed of the recessed area 104 and islands 107 with holes 109 in them to accept Flanged Connectors which are described later. On the back side of the Concentrate Water Spacer 100, there is an identical Recessed Spaces Leaving Islands Region to the Recessed Spaces Leaving Islands Region 115 composed of identical recessed areas, islands, and holes to that of the front side, that are not shown. The top front side of the Recessed Spaces Leaving Islands Region 118 is composed of the recessed area 105 and islands 106 with holes 108 in them to accept Flanged Connectors which are described later. On the back side of the Concentrate Water Spacer 100, there is an identical Recessed Spaces Leaving Islands Region to Recessed Spaces Leaving Islands Region 118 composed of identical recessed areas, islands, and holes to that of the front side, that are not shown. The islands are on-the-order of 3-inches on a side and the recessed areas are one-half-inch deep. Material is removed from the original flat rectangular block to form a Large Empty Space 102 in the central part of the Concentrate Water Spacer 100. When ion exchange membranes, which are not shown, are installed on each side of a Concentrate Water Spacer, concentrate water will enter the Concentrate Water Spacer 100 at hole 113, pass through the Small Empty Space 111, over the recessed area 104 and around the islands 107 as well as like ones on the back side not shown, through the Large Empty Space 102, over the recessed area 105 and around the islands 106 as well as like ones on the back side not shown, through the Small Empty Space 110, and exit the hole 112. The input dilute water will pass through Flanged Connectors that are inserted into the Holes 109 while the output dilute water will pass through Flanged Connectors that are inserted into the Holes 108. The Flanged Connectors are described later.

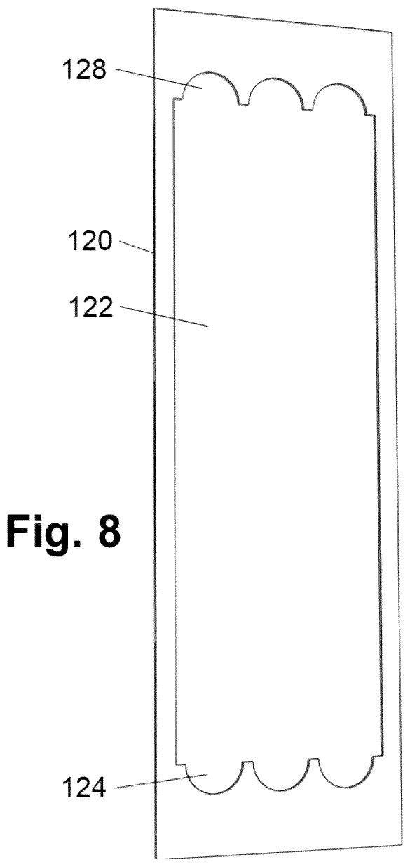

The Dilute Water Spacer 120 is illustrated in FIG. 8. It has outer dimensions of 42 inches tall, 13 inches wide, and typically between ⅛ and ¼ inch thick with compressed gaskets and is made from a flat rectangular shaped block of non-electrical conducting material like plastic of which polypropylene is an example. The Dilute Water Spacer is created by removing material from a large open space 122 in the central region of the spacer. The back side of the Dilute Water Spacer 120 looks identical to its front side. When ion exchange membranes, which are not shown, are placed on each side of the Dilute Water Spacer, the dilute water will enter at the bottom of the Dilute Water Spacer 124 from flanged connectors installed in one ion exchange membrane protruding into the lower open space 122 in the Dilute Water Spacer 120, pass upward through the dilute water spacer open space 122, and out of the upper open space through flanged connectors installed in another adjacent ion exchange membrane.

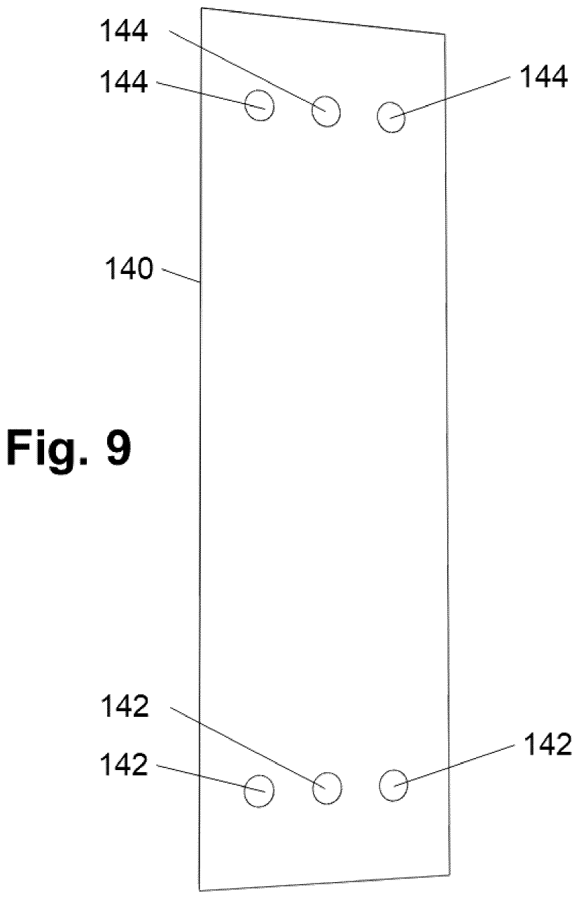

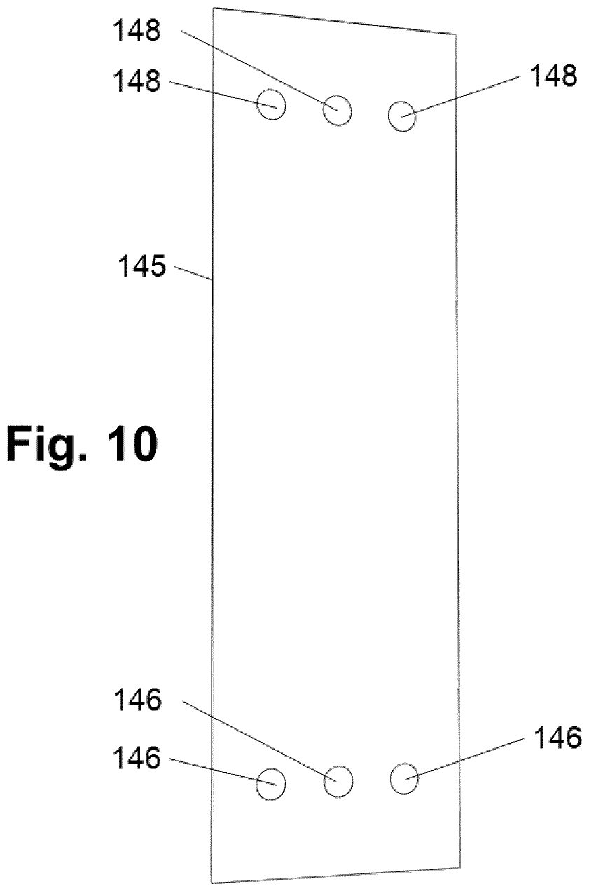

The Cation Ion Exchange Membrane 140 in FIG. 9 and the Anion Ion Exchange Membrane 145 in FIG. 10 are identical in shape with dimensions of 42 inches tall, 13 inches wide, and about 20 mils thick. There are three 1½ inch holes 142 near the bottom and three 1½ inch holes 144 near the top of the Cation Ion Exchange Membrane 140. Likewise, there are three 1½ inch holes 146 near the bottom and three 1½ inch holes 148 near the top of the Anion Ion Exchange Membrane 145. The holes are of the same size and at the same relative locations as the like holes in the islands in the Concentrate Water Spacer. The holes in the membranes are there for dilute water to pass into and out of the Anion and Cation Ion Exchange Membrane 145 and 140 respectively through inserted flanged connectors described later. The back side of the Cation and Anion Ion Exchange Membranes 140 and 145 respectively would look identical to their front side.

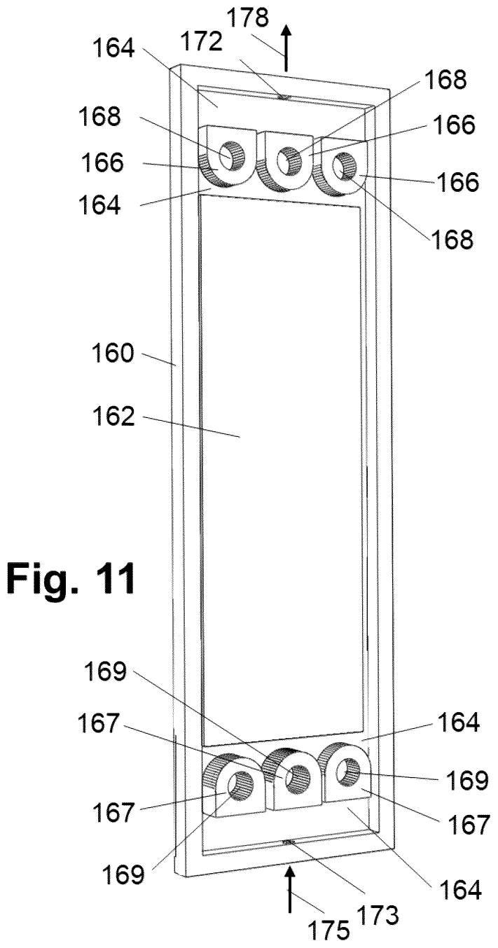

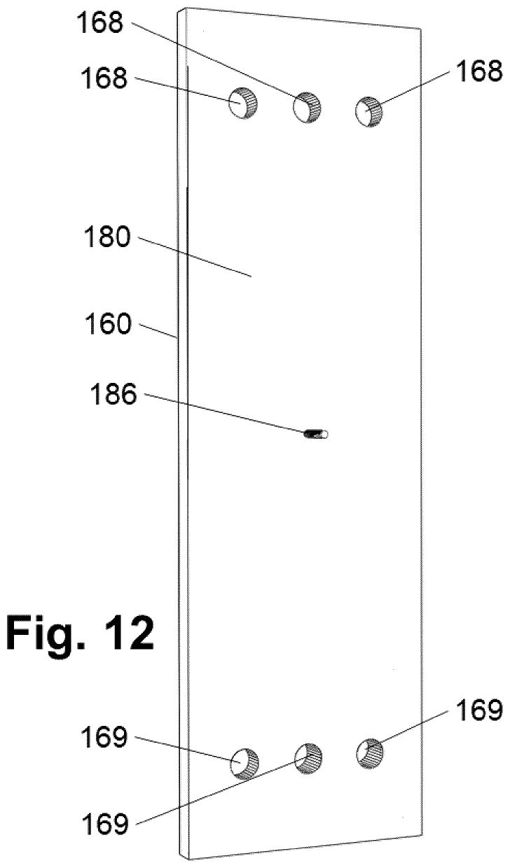

The front and back views of the identically constructed Anolyte and Catholyte Water Spacers 160 are illustrated in FIGS. 11 and 12 respectively. Their only difference is the DC Power Supply's negative terminal is attached to the Inert Electrode, which is called the Cathode, located in the Catholyte Water Spacer and its positive terminal is attached to the Inert Electrode, which is called the Anode, located in the Anolyte Water Spacer. This description of the Anolyte and Catholyte Water Spacers in-part begins by assuming there is a flat rectangular block of non-electrical conducting material like plastic of which polypropylene is an example. Then material is removed from it to form (1) Recessed Spaces Leaving Islands Region, and (2) Holes. Their outer dimensions are 42 inches tall, 13 inches wide, and about 1¼ inch thick. The large recessed area 164 is recessed on the order of 1-inch on only the front of the spacer and this large recessed area contains an Inert Electrode 162, that is about ⅛ inch thick, as shown in FIG. 11. There is an input anolyte or catholyte water threaded hole 173, which can house a water fitting, that extends from the bottom of the spacer to the recessed area 164 that is used to bring the anolyte or catholyte water 175 into the interior of the Anolyte or Catholyte Water Spacer 160. There is also an output anolyte or catholyte water threaded hole 172, which can house a water fitting, that extends from the recessed space 164 to the top of the spacer that is used to remove the anolyte or catholyte water 178 from the interior of the Anolyte or Catholyte Water Spacer 160. Near the bottom and top of the Anolyte or Catholyte Water Spacer 160 in FIG. 11, there are three Islands 167 and 166 respectively which are left after removing material to form the recessed areas. The Islands are about 3 inches on a side and have Holes 168 and 169 in their center that are one and one-half-inch in diameter that extend all the way to the back side as shown in FIG. 12. The Islands 167 and 166 and their Holes 168 and 169 are identical in shape and relative position to those in the Concentrate Water Spacer previously described. There is an Electrode Connector 186 that passes from the Inert Electrode 162 shown in FIG. 11 through the back of the Anolyte or Catholyte Spacers 160 as shown in FIG. 12. The DC Power Supply terminals will eventually attach to these Electrode Connectors. The back sides of the Anolyte and Catholyte Spacers 180 are flat and solid except for the Holes 168 and 169 and the protruding Electrode Connector 186 as shown in FIG. 12. There will eventually be a Cation Ion Exchange Membrane, which is not shown, on the front side of the Anolyte or Catholyte Water Spacers 160. Then anolyte or catholyte water 175 will enter the Anolyte or Catholyte Spacer 160 at the hole 173, pass into the recessed area 164, over the recessed areas 164 between and around the Islands 167, over the Inert Electrode 162, over the recessed areas 164 between and around the Islands 166, through the remaining recessed area 164, and exit the hole 172. The input dilute water will pass through Flanged Connectors inserted into the holes 169 while the output dilute water will pass through Flanged Connectors inserted into the holes 168. The Flanged Connectors will be described later.

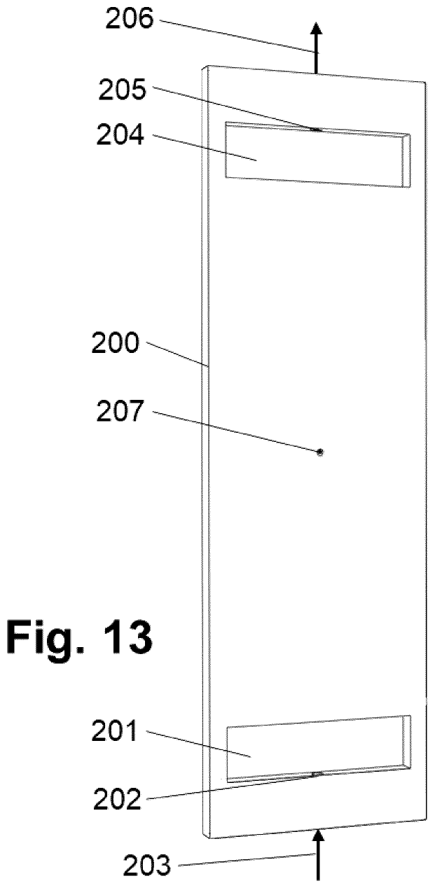

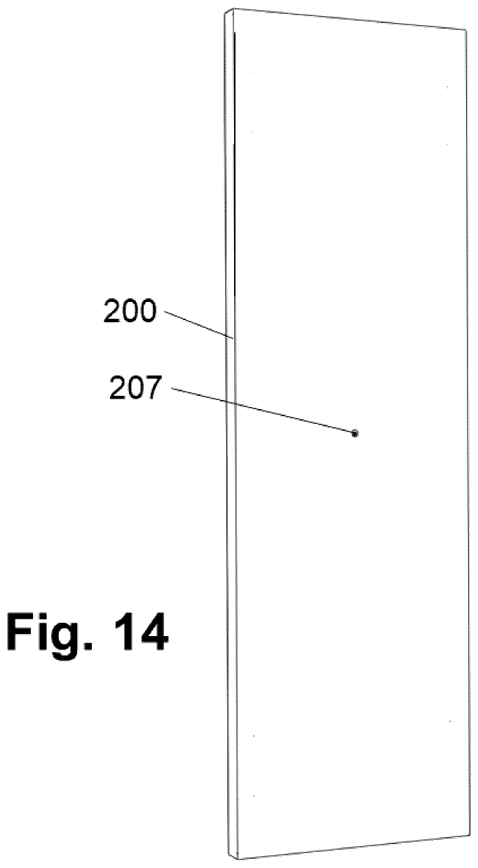

The front and back views of the Covers 200 are illustrated in FIGS. 13 and 14 respectively. This description of the Covers begins by assuming there is a flat rectangular block of non-electrical conducting material like plastic of which polypropylene is an example. Then material is removed from it to form (1) Recessed Space Regions, and (2) Holes. Their outer dimensions are 42 inches tall, 13 inches wide, and about 1¼ inch thick. There are recessed areas 201 and 204 near the bottom and top of the Cover 200 respectively that are about 1 inch deep. The recessed areas are the same size and at the same locations as the Recessed Spaces Leaving Islands Regions of the Concentrate Water Spacer. There are threaded Holes 202 and 205, which can accept a water fitting, that go from the bottom and top edges of the Cover to the recessed areas 201 and 204 respectively. Dilute water 203 will pass into Hole 202 and out through Flanged Connectors housed in the Anolyte or Catholyte Water Spacer, which are not shown, that protrude into the open space 201. Dilute water will also pass into the open space 204 from protruding Flanged Connectors housed in the Anolyte or Catholyte Water Spacer, which are not shown, and this dilute water 206 will pass out Hole 205. The Flanged Connectors will be described later. The back side of the Cover 200 is solid and flat except for the Hole 207 that will pass the Electrode Connector through it as shown in both FIG. 13 and FIG. 14.

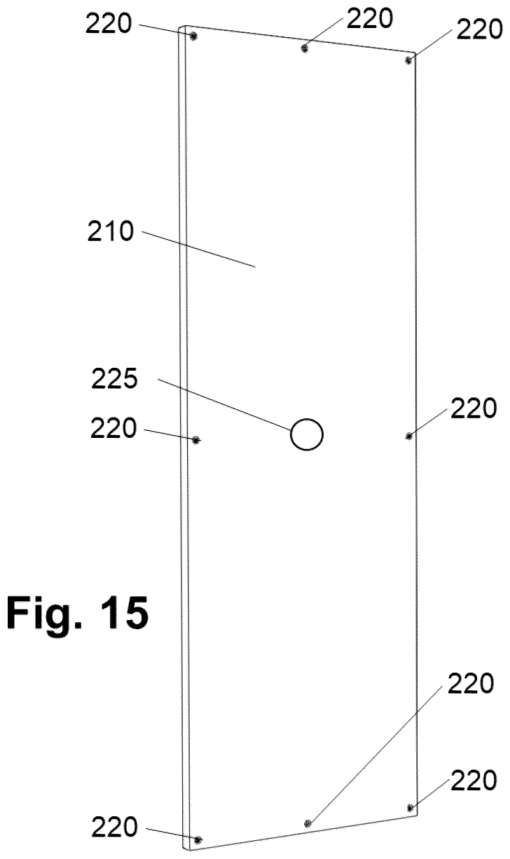

The Compression Plate 210 is shown in FIG. 15. Its outer dimensions are 44 inches tall and 15 inches wide, which are larger than the other spacers, ion exchange membranes, and covers. It is about ½ inch thick and is made of a strong metal where steel is an example. There are bolt holes 220 near the perimeter of the Compression Plate 210. There is a hole 225 in the center of the Compression Plate 210 so as to accommodate the projection of the electrode screw 186 shown in the Anolyte and Catholyte Water Spacers in FIG. 12. The back side of the Compression Plate 210 looks identical to its front side.

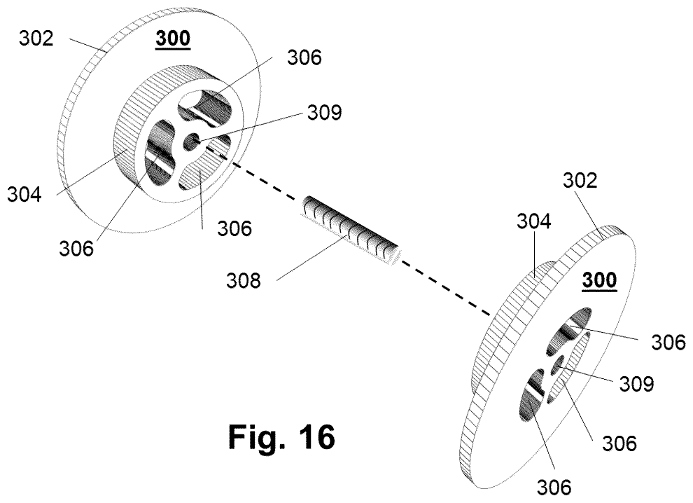

Two Flanged Connectors 300 plus a connecting Threaded Rod 308 between them are shown in an exploded view in FIG. 16. The cylindrical part 304 of the Flanged Connector 300, which is about 1⅜ inch in diameter and ⅜ inch tall, has holes 306 in it for dilute water to pass through. There is a threaded hole 309 in the center of the cylindrical part 304 for the Threaded Rod 308 to screw into. There is a flange 302 surrounding the cylindrical part 304 of the Flanged Connector 300 that is about 2½ inch in diameter and 1/16 inch thick. When the two Flanged Connectors 300 are screwed onto the Threaded Rod 308 and turned, the distance between the two Flanged Connectors 300 becomes longer or shorter depending on the directions the Flanged Connectors 300 are turned.

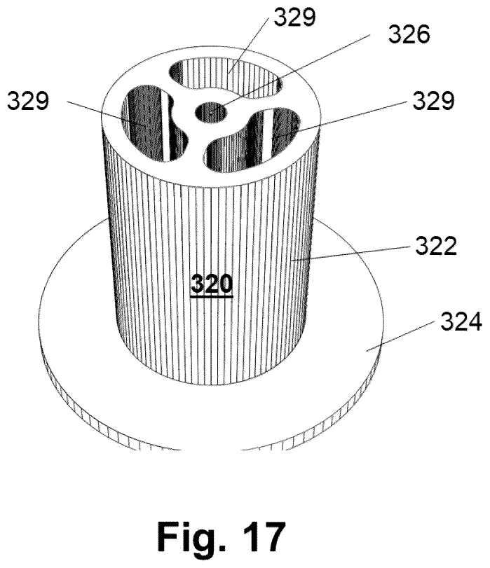

An Elongated Flanged Connector 320 is shown in FIG. 17. It is identical to the Flanged Connectors 300 of FIG. 16 except its cylindrical part 322 is taller by about 2 inches. There are holes 329 in the cylindrical part 322 for dilute water to pass through. There is a threaded hole 326 in the center of the cylindrical part 322. There is a flange 324 surrounding the cylindrical part 322 of the Elongated Flanged Connector 320 that is about 2½ inch in diameter and 1/16 inch thick. These Elongated Flanged Connectors 320 are used in place of the Flanged Connectors 300 of FIG. 16 in one area of the Electrodialysis Stack.

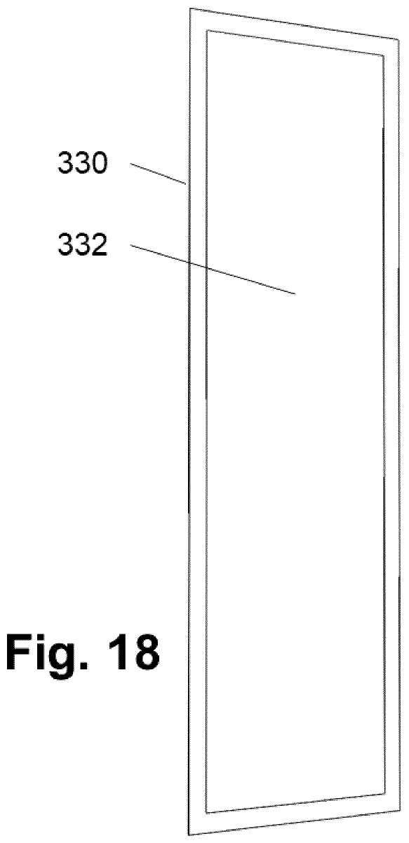

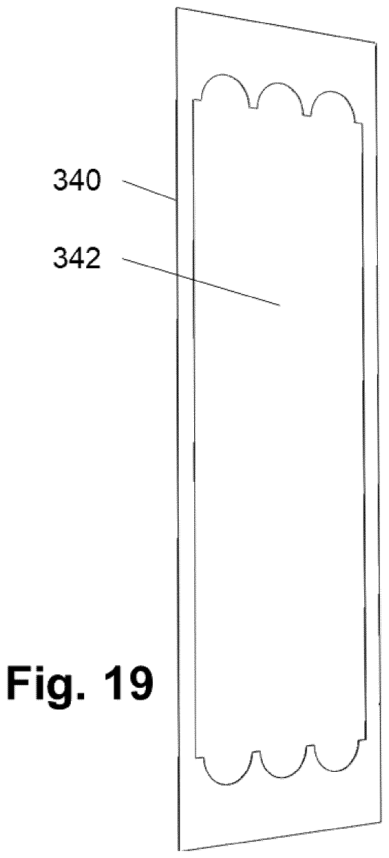

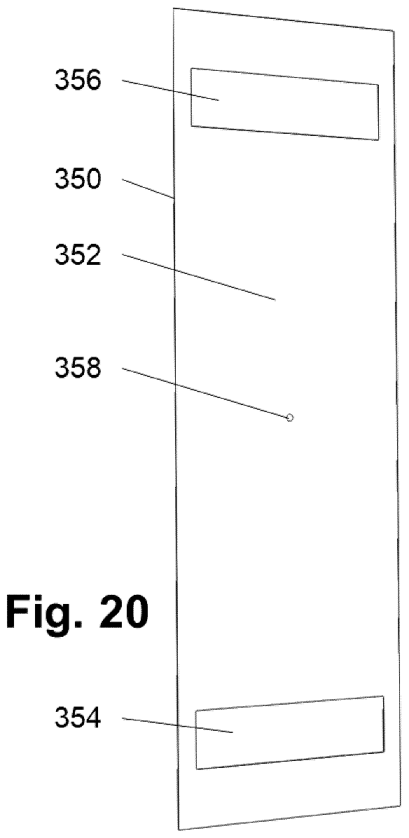

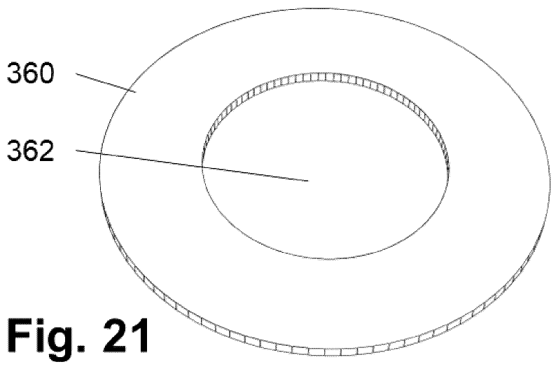

FIG. 18 illustrates the Concentrate Water Spacer Gasket 330. The Anolyte and Catholyte Water Spacer Gaskets are identical to the Concentrate Water Spacer Gasket 330 and are only used on the front faces of the Anolyte and Catholyte Spacers. There is a large open space 332 in the gaskets 330. FIG. 19 illustrates the Dilute Water Spacer Gasket 340 that has a large open space 342 in the gasket. FIG. 20 illustrates the Cover Gasket 350 which has open spaces 354 and 356 near the bottom and top of the Cover Gasket 350 respectively and a hole in its center 358, but is otherwise solid 352. All the Concentrate Water, Anolyte, Catholyte, Dilute Water, and Cover Gaskets have outer dimensions of 42 inches tall, 13 inches wide, and about 1/16 inch thick. FIG. 21 illustrates the Flanged Connector and Elongated Flanged Connector Gaskets 360 which are about 2½ inch in diameter, has an open space 362 about 1½ inch in diameter, and is 1/16 inch thick. All the gaskets are made of either rubber, cork, or other similar gasket materials and typically are 1/32 inch thick when compressed.

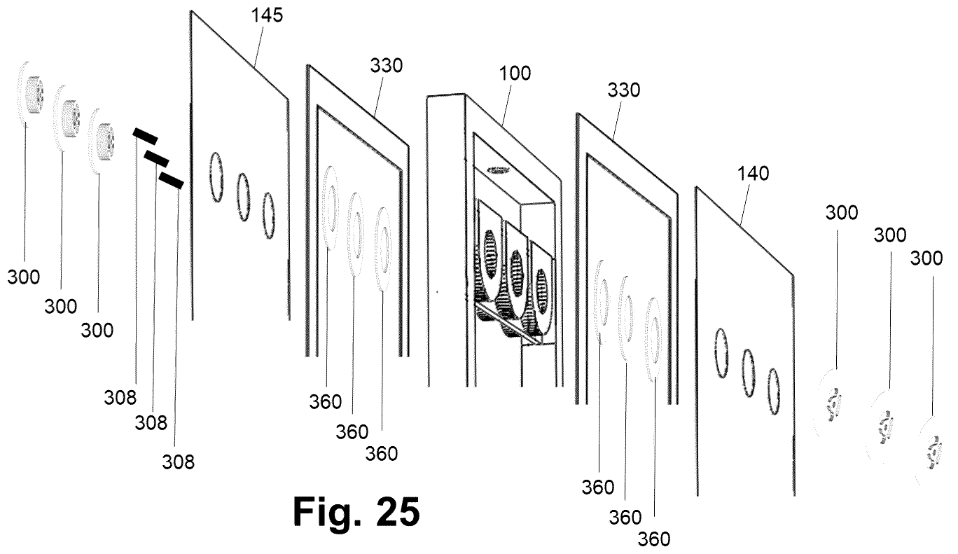

FIG. 22 illustrates an exploded view of how a set of Concentrate and Dilute Water Spacers, Anion and Cation Ion Exchange Membranes, and associated gaskets are stacked. Starting from the left, the sequence of items is Dilute Water Spacer Gasket 340, Dilute Water Spacer 120, Dilute Water Spacer Gasket 340, Anion Ion Exchange Membrane 145, Concentrate Water Spacer Gasket 330, Concentrate Water Spacer 100, Concentrate Water Spacer Gasket 330, and Cation Ion Exchange Membrane 140. This sequence of items is repeated from left to right in the central portion of the electrodialysis stack. For now, note that the sequence of Dilute Water Spacer Gasket 340, Dilute Water Spacer 120, Dilute Water Spacer Gasket 340 is defined as the Dilute Group. The sequence of Anion Ion Exchange Membrane 145, Concentrate Water Gasket 330, Concentrate Water Spacer 100, Concentrate Water Gasket 330, and Cation Ion Exchange Membrane 140 is defined as the Concentrate Group but without the Flanged Connectors and Flanged Connector Gaskets which will be included when the Concentrate Group is fully discussed in FIG. 25.

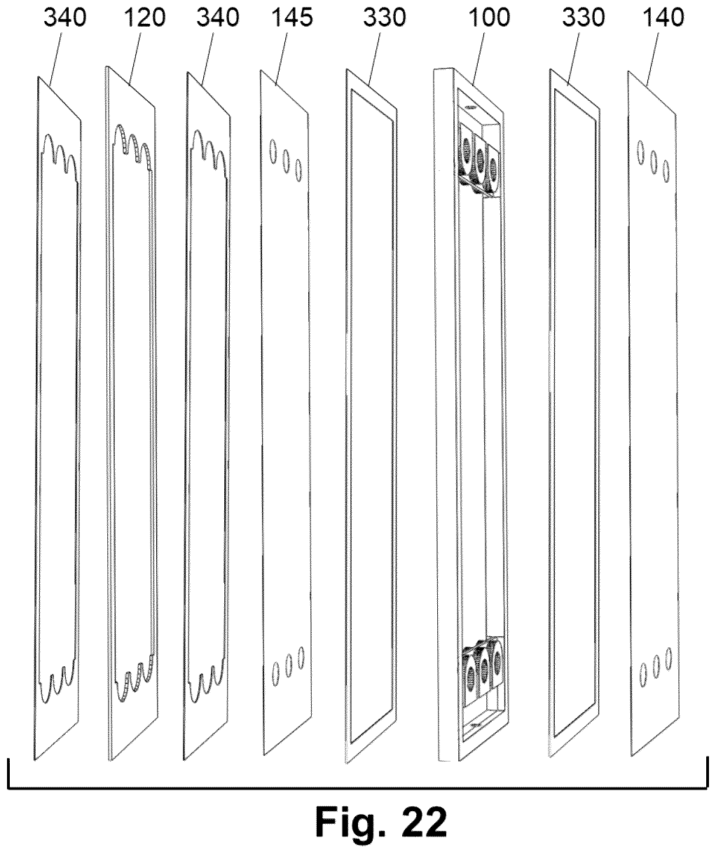

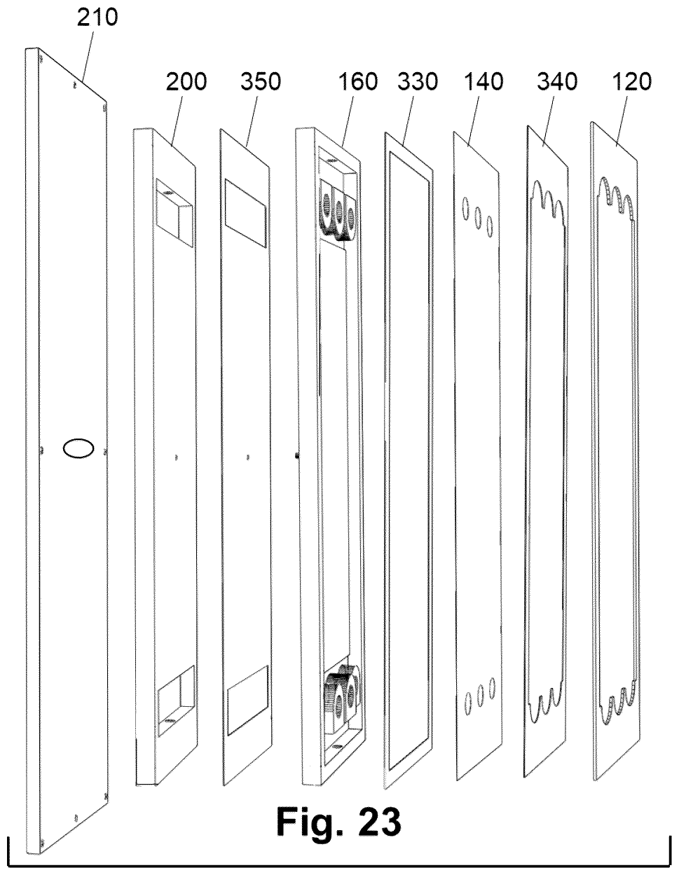

FIG. 23 illustrates an exploded view of how a set of Catholyte Water and Dilute Water Spacers, Cation Ion Exchange Membrane, Cover, Compression Plate, and associated gaskets are stacked near the Inert Cathode Electrode. Starting from the left, the sequence of items is Compression Plate 210, Cover 200, Cover Gasket 350, Catholyte Water Spacer 160, Catholyte Spacer Gasket 330, Cation Ion Exchange Membrane 140, Dilute Water Spacer Gasket 340, and Dilute Water Spacer 120.

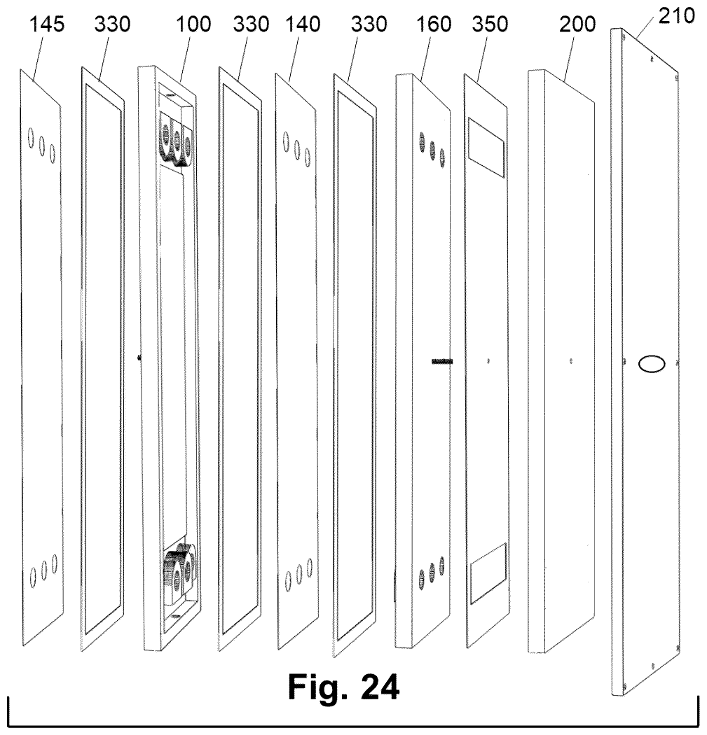

FIG. 24 illustrates an exploded view of how a set of Concentrate Water and Anolyte Water Spacers, Anion and Cation Ion Exchange Membranes, Cover, Compression Plate, and associated gaskets are stacked near the Inert Anode Electrode. Starting from the left, the sequence of items is Anion Ion Exchange Membrane 145, Concentrate Water Spacer Gasket 330, Concentrate Water Spacer 100, Concentrate Water Spacer Gasket 330, Cation Ion Exchange Membrane 140, Anolyte Water Spacer Gasket 330, Anolyte Water Spacer 160, Cover Gasket 350, Cover 200, and Compression Plate 210.

FIGS. 22, 23, and 24 showed how the components of the electrodialysis stack are stacked but does not show how the Flanged Connectors and Elongated Flanged Connectors are used in the stack to eliminate interior leaks of the various waters within the stack. FIGS. 25, 26, and 27 illustrate how the Flanged Connectors and Elongated Flanged Connectors are used. FIG. 25 illustrates how the Flanged Connectors are used to compress the Anion and Cation Ion Exchange Membranes against the gasketed Concentrate Water Spacer so there is no leak between the concentrate and dilute waters. In the exploded partial view shown in FIG. 25, there is a sequence of assembled components from left to right of Flanged Connectors 300, Treaded Rods 308, Anion Ion Exchange Membrane 145, combination of Concentrate Water Spacer Gasket 330 and Flanged Connector Gaskets 360, Concentrate Water Spacer 100, combination of Flanged Connector Gaskets 360 and Concentrate Water Spacer Gasket 330, Cation Ion Exchange Membrane 140, and Flanged Connectors 360. The Threaded Rod 308 screws into the Flanged Connectors 300 on the left, transverses through all the just stated components and screws into the Flanged Connectors 300 on the right. The Flanged Connectors' 300 flanges will extend into the Dilute Water Spacers that are not shown. When the Flanged Connectors 300 are tightened, they compress the assembled components together to prevent leaks between the dilute and concentrate water as the dilute water passes through the central parts of the Flanged Connectors 300. The entire assembly in FIG. 25 is defined as the Concentrate Group. The interior of an electrodialysis stack is made up with multiple alternating Dilute Groups defined with the discussion on FIG. 22 and Concentrate Groups fully defined here.

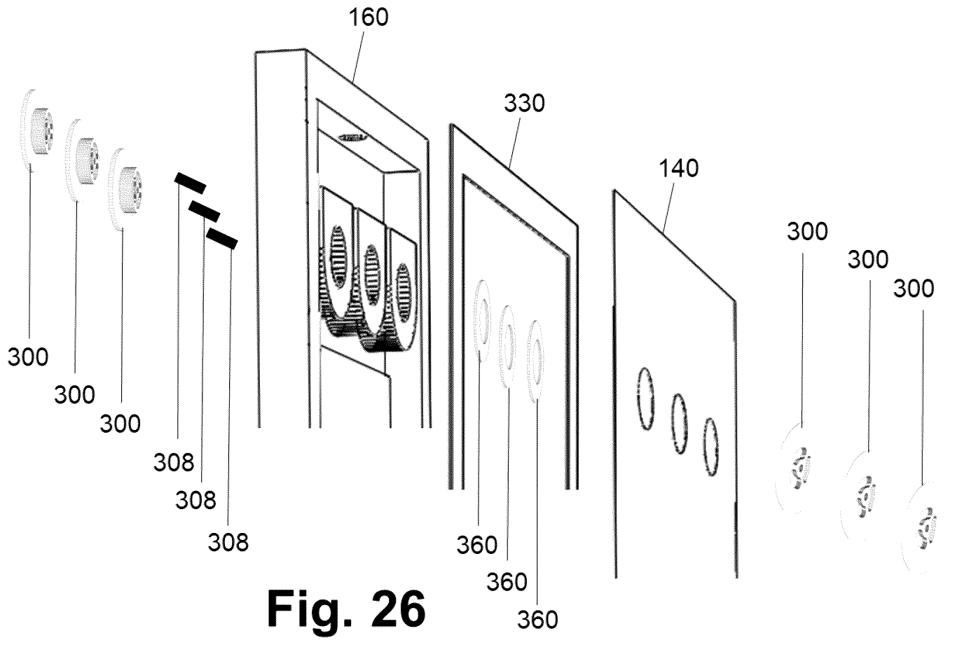

The Flanged Connectors near the Inert Cathode Electrode are used differently. In the exploded view shown in FIG. 26, there is a sequence of assembled components from left to right of Flanged Connectors 300, Treaded Rods 308, Catholyte Water Spacer 160, combination of Flanged Connector Gaskets 360 and Catholyte Water Spacer Gasket 330, Cation Ion Exchange Membrane 140, and Flanged Connectors 300. The Threaded Rods 308 screws into the Flanged Connectors 300 on the left, transverses through all the assembled components just stated and screws into the Flanged Connectors 300 on the right. The Flanged Connectors' 300 flanges will extend into the Cover on the left and the Dilute Water Spacer on the right neither which are not shown. When the Flanged Connectors 300 are tightened, they compress the assembled components together at the hole locations to prevent leaks between the dilute and catholyte water as the dilute water passes through the central parts of the Flanged Connectors 300. The entire assembly shown in FIG. 26 is defined as the Cathode Group.

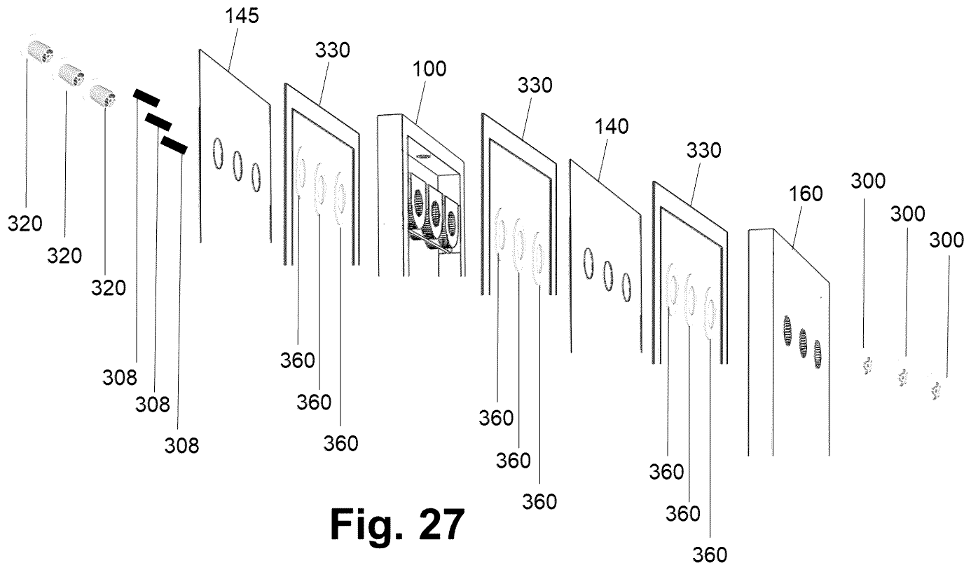

The Flanged Connectors near the Inert Anode Electrode are used differently. In the exploded view shown in FIG. 27, there is a sequence of assembled components from left to right is Elongated Flanged Connectors 320, Treaded Rods 308, Anion Ion Exchange Membrane 145, combination of Concentrate Water Spacer Gasket 330 and Flanged Connector Gaskets 360, Concentrate Water Spacer 100, combination of Flanged Connector Gaskets 360 and Concentrate Water Spacer Gasket 330, Cation Ion Exchange Membrane 140, combination of Flanged Connector Gaskets 360 and Anolyte Water Spacer Gasket 330, Anolyte Water Spacer 160, and Flanged Connectors 300. The Threaded Rod 308 screws into the Elongated Flanged Connectors 320 on the left, transverses through all the components just stated and screws into the Flanged Connectors 300 on the right. The Elongated Flanged Connectors' 320 flanges will extend into the Dilute Water Spacer on the left and the Flanged Connectors' 300 flanges will extend into the Cover on the right neither which are shown. When the Flanged Connectors 300 and Elongated Flanged Connectors 320 are tightened, they compress the components together at the hole locations to prevent leaks between the dilute, concentrate, and anolyte water as the dilute water passes through the central parts of the Flanged Connectors 300 and Elongated Flanged Connectors 320. The entire assembly shown in FIG. 27 is defined as the Anode Group.

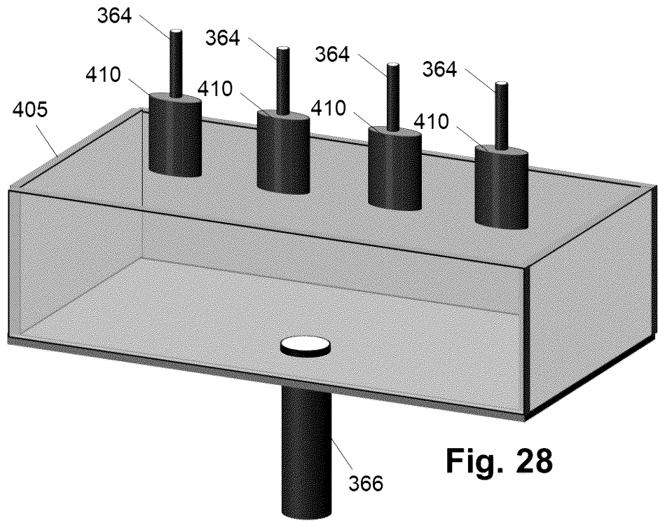

The Concentrate Water Manifold 405 in FIG. 28 is illustrated as a hollow box and is the same as the Concentrate Water Manifold 33 shown in FIG. 2. The front of the box is semi-transparent so one can see inside the box. The Concentrate Water Manifold 405 is fed with concentrate water from the Concentrate Water Enhanced Clarifier and Pump 32 shown in FIG. 2 through tube 366. In this case, the concentrate water exits the Concentrate Water Manifold 405 at four locations, passes through a corresponding set of four Check Valves 410, and then exits through four tubes 364. The output of these four tubes 364 will be fed to the bottoms of four Concentrate Water Spacers. The Check Valves 410 allows the concentrate water to flow in the upward direction, but prevents the concentrate water from flowing in the downward direction. When the Check Valve is closed, the concentrate water on each side of it is electrically isolated from each other. An alternative to the Check Valves is electrically activated normally closed valves which open when the concentrate water pump is activated. An alternative to electrically isolated valves is to drain the concentrate water from the feed side of valve when the valve is closed and feed the valve using plastic tubing. An option that is not shown in FIG. 28 is to not use all the Check Valves 410 after the Concentrate Water Manifold 405, but to replace these Check Valves with tubes and use a single Check Valve before the Concentrate Water Manifold 405 which is only applicable when the dilute water has a high enough conductivity and the electrical resistance of the ion exchange membranes is low enough so that the current and associated power loss is low during the desalination operation.

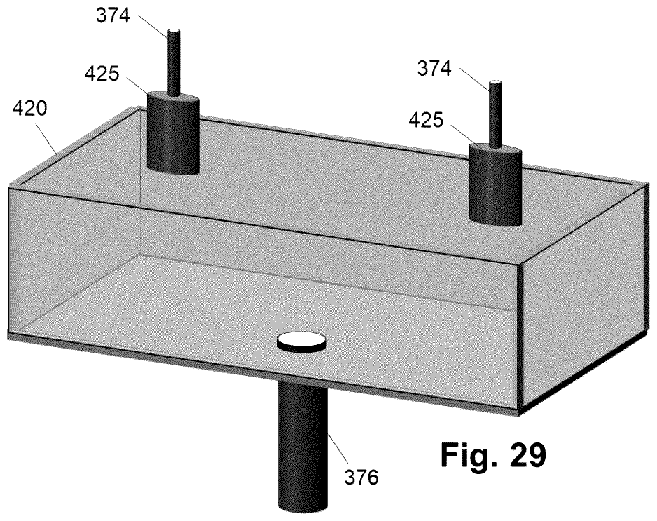

The Electrolyte Water Manifold 420 in FIG. 29 is illustrated as a hollow box and is the same as the Electrolyte Water Manifold 43 shown in FIG. 3. The front of the box is semi-transparent so one can see inside the box. The Electrolyte Water Manifold 420 is fed with electrolyte water from the Electrolyte Water Reservoir and Pump 42 shown in FIG. 3 through tube 376. The electrolyte water exits the Electrolyte Water Manifold 420 at two locations, passes through a corresponding set of two Check Valves 425, and then exits through two tubes 374. The output of one of the tubes 374 will be fed to the bottom of the Anolyte Water Spacer and the output of the other tube 374 will be fed to the bottom of the Catholyte Water Spacer. The Check Valves 425 allows the electrolyte water to flow in the upward direction, but prevents the electrolyte water from flowing in the downward direction. When the Check Valve is closed, the electrolyte water on each side of it is electrically isolated from each other. An alternative to the Check Valves is electrically activated normally closed valves which open when the electrolyte water pump is activated. An alternative to electrically isolated valves is to drain the electrolyte water from the feed side of valve when the valve is closed and feed the valve using plastic tubing.

The Concentrate Water Container 415 in FIG. 30 is illustrated as a hollow box and is the same as the Concentrate Water Container 35 shown in FIG. 2. The front of the box is semi-transparent so one can see inside the box. In this case, the Concentrate Water Container 415 is fed with concentrate water from the tops of the Concentrate Water Spacers that are located below it through four tubes 368. These tubes 368 extend into the interior of the Concentrate Water Container 415 so that when the concentrate water pump operates, the nominal water level within the Concentrate Water Container 415 cannot be above the height of the tubes 368 when the concentrate water is flowing. There is space between the extended tubes 368 and the ceiling of the interior of the Concentrate Water Container 415. There is a Drain 380 in the floor of the Concentrate Water Container 415 that drains the concentrate water back to the Concentrate Water Enhanced Clarifier and Pump 32 as shown in FIG. 2 by use of gravity. The top is either open or there is a hole in the top of the Concentrate Water Container 415 so as to equalize the pressure so the water in the Concentrate Water Container 415 will quickly drain once the pump stops. So, when the concentrate water pump is operating, the concentrate water flows up the tubes 368 from the tops of the Concentrate Water Spacers and spills over onto any water residing on the floor of the Concentrate Water Container 415. This water then quickly drains back to the Concentrate Water Enhanced Clarifier and Pump 32 shown in FIG. 2. When the concentrate water pump stops, concentrate water is contained and stationary in each Concentrated Water Spacer and associated tubes 368 but there is no water between the tubes 368 so that the stationary concentrate waters contained in the tubes 368 are isolated from another. Alternatives to the Concentrate Water Container 415 in FIG. 30 is the tubes 368 can enter the side or top of the Concentrate Water Container 415.

The Electrolyte Water Container 430 in FIG. 31 is illustrated as a hollow box and is the same as the Electrolyte Water Container 45 shown in FIG. 3. The front of the box is semi-transparent so one can see inside the box. The Electrolyte Water Container 430 is fed with anolyte water from the top of the Anolyte Water Spacer that is located below it through one tube 388 and catholyte water from the top of the Catholyte Water Spacer that is located below it through another tube 388. These tubes 388 extend into the interior of the Electrolyte Water Container 430 so that when the electrolyte water pump operates, the nominal water level within the Electrolyte Water Container 430 cannot be above the height of the tubes 388 when the electrolyte water is flowing. There is space between the extended tubes 388 and the ceiling of the interior of the Electrolyte Water Container 430. There is a Drain 386 in the floor of the Electrolyte Water Container 430 that drains the electrolyte water back to the Electrolyte Water Reservoir and Pump 42 as shown in FIG. 3 by use of gravity. The top is either open or there is a hole in the top of the Electrolyte Water Container 430 so as to equalize the pressure so the water in the Electrolyte Water Container 430 will quickly drain once the pump stops. So, when the electrolyte water pump is operating, the electrolyte water flows up the tubes 388 from the tops of the Anolyte and Catholyte Water Spacers and spills over onto any water residing on the floor of the Electrolyte Water Container 430. This water then quickly drains back to the Electrolyte Water Reservoir and Pump 42 shown in FIG. 3. When the electrolyte water pump stops, electrolyte water is contained and stationary in the Anolyte and Catholyte Water Spacers and associated tubes 388 but there is no water between the tubes 388 so that the stationary anolyte and catholyte waters in the tubes 388 are isolated from another. Alternatives to the Electrolyte Water Container 430 in FIG. 31 is the tubes 388 can enter the side or top of the Electrolyte Water Container 430.

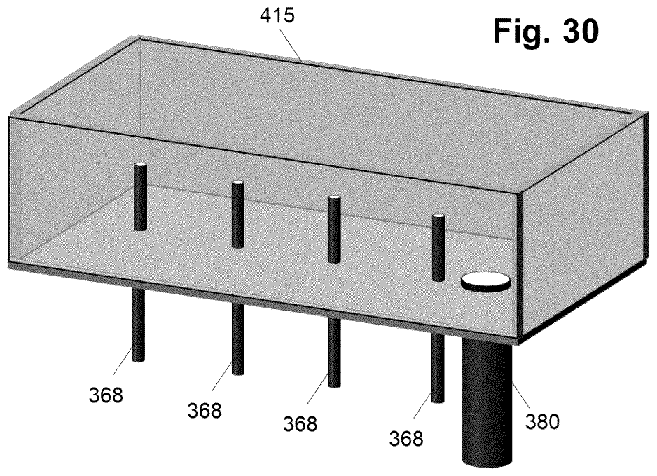

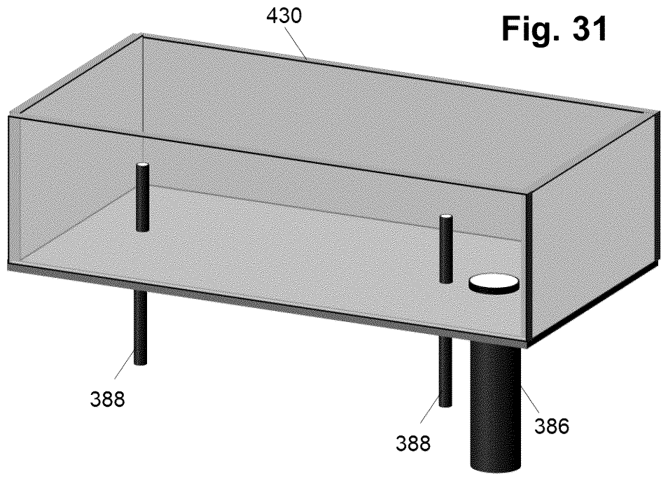

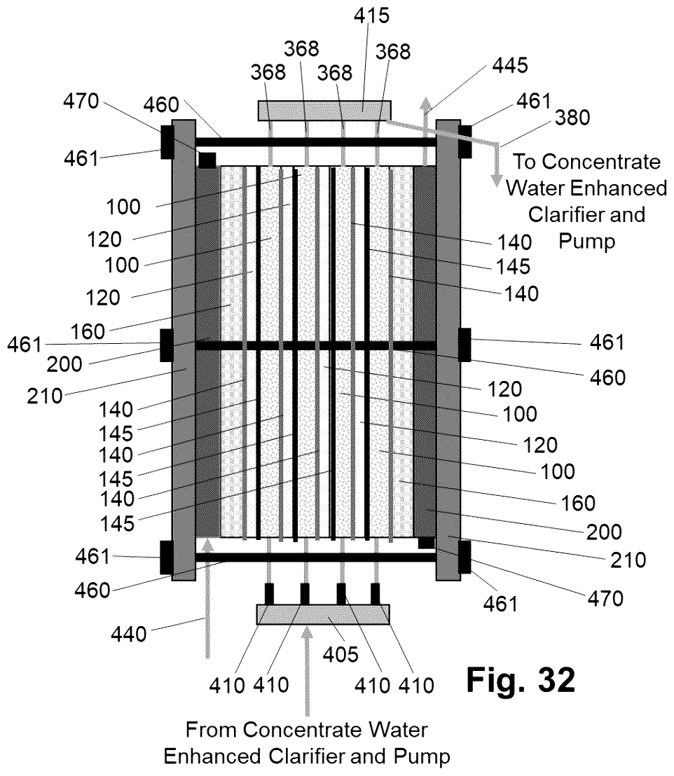

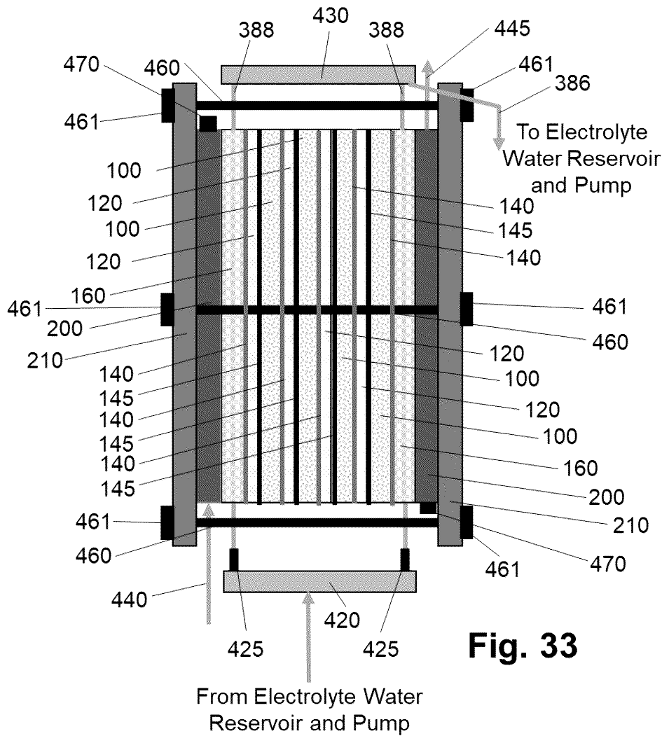

FIG. 32 illustrates the assembled side view of the GED invention's electrodialysis stack when there are four Dilute Water Spacers 120 present plus the feed and retrieval components of the concentrate water but not the feed and retrieval components of the electrolyte water. FIG. 33 illustrates the assembled side view of the GED invention's electrodialysis stack when there are four Dilute Water Spacers 120 which is the same as FIG. 32 but this figure shows the feed and retrieval components of the electrolyte water but not the feed and retrieval components of the concentrate water. The common portions of FIGS. 32 and 33 are first described. The thin gaskets are not included in these figures. There are Compression Plates 210 on the far left and far right side of the electrodialysis stack. Next to the interior of the Compression Plates 210 are the Covers 200 followed by the Catholyte Water Spacer 160 on the left and the Anolyte Water Spacer 160 on the right. Starting at the interior of the Catholyte Water Spacer 160 on the left, there is a Cation Ion Exchange Membrane 140 followed by a Dilute Water Spacer 120, followed by an Anion Ion Exchange Membrane 145, followed by a Concentrate Water Spacer 100. This sequence of Cation Ion Exchange Membrane 140 followed by a Dilute Water Spacer 120, followed by an Anion Ion Exchange Membrane 145, followed by a Concentrate Water Spacer 100 is repeated from left to right until four Dilute Water Spacers 120 have been implemented plus one Cation Ion Exchange Membrane 140 between the last Concentrate Water Spacer 100 on the right and the Anolyte Water Spacer 160 on the right. There are Threaded Rods 460 that pass through the Compression Plates 210 and are secured on each end by Nuts 461. When the Nuts are tightened, the stack of components on their interior are compressed. The dilute water enters the left side Cover 200 from below at 440 and exits the right-side Cover 200 from above at 445. The Cover 200 on the left top side has a Plug 470 at the output port and the Cover 200 on the right bottom side has a Plug 470 at the input port.

The concentrate water distribution system is described with the aid of FIG. 32. From below, concentrate water from the Concentrate Water Enhanced Clarifier and Pump 3 of FIG. 1 enters into the Concentrate Water Manifold 405 which distributes it to four Check Valves 410 and then on into the bottoms of the four Concentrate Water Spacers 100. The concentrate water leaves the top of the four Concentrate Water Spacers 100 and feed into the Concentrate Water Container 415 through four tubes 368. Then, concentrate waters enters the Concentrate Water Container 415 and drains 380 by gravity into the Concentrate Water Enhanced Clarifier and Pump 3 of FIG. 1. Although not shown in a figure, the Check Valves 410 after the Concentrate Water Manifold 405 in FIG. 32 can be replaced with tubes and a single Check Valve before the Concentrate Water Manifold can be added when the conductivity of the dilute water is high enough and the electrical resistance of the ion exchange membranes is low enough so that there is only a little current and associated power loss when desalination is being performed. This single Check Valve is still required to maintain the very low average concentrate water flow rate.

The electrolyte water distribution system is described with the aid of FIG. 33. From below, electrolyte water from the Electrolyte Water Reservoir and Pump 4 of FIG. 1 enters into the Electrolyte Water Manifold 420 which distributes it to two Check Valves 425 and then on into the bottoms of the Catholyte Water Spacer 160 on the left and the Anolyte Water Spacer 160 on the right. The catholyte and anolyte water leaves the top of the Catholyte and Anolyte Spacers 160 on the left and the right respectively and feed into the Electrolyte Water Container 430 through two tubes 388. Then, electrolyte water enters the Electrolyte Water Container 430 and drains 386 by gravity into the Electrolyte Water Reservoir and Pump 4 of FIG. 1.

The dimensions of the electrodialysis stack for this example consisting of the previously described components consisting of 4 Concentrate Water Spacers, 4 Dilute Water Spacers, 4 Anion Ion Exchange Membranes, 5 Cation Ion Exchange Membranes, 1 Catholyte Water Spacer, 1 Anolyte Water Spacer, 2 Covers, and 2 Compression plates is on the order of 15-inches wide, 44-inches tall and 15-inches deep. Two examples will be given later that consists of 20 Concentrate Water Spacers, 20 Dilute Water Spacers, 20 Anion Ion Exchange Membranes, 21 Cation Ion Exchange Membranes rather that 4 Concentrate Water Spacers, 4 Dilute Water Spacers, 4 Anion Ion Exchange Membranes, and 5 Cation Ion Exchange Membranes and their dimensions are on the order of 36-inches wide, 44-inches tall, and 15-inches deep. For this larger unit, the Concentrate Water Manifold size would be on the order of 36-inches wide, 3-inches deep, and 3-inches high. The Electrolyte Water Manifold is simply a water divider and the size is on the order of an inch. The Check Valves would be on the order 1-inch in diameter, and 3-inches tall. For this larger unit, the Concentrate Water Container size would be on the order of 36-inches wide, 3-inches deep and 14-inches high. The Electrolyte Water Container size would be on the order of 6-inches wide, 3-inches deep and 14-inches high. The vertically oriented tubes inside the Concentrate and Electrolyte Water Containers for the larger example would have an inside diameter of about ½ inch and a height of about 12 inches.

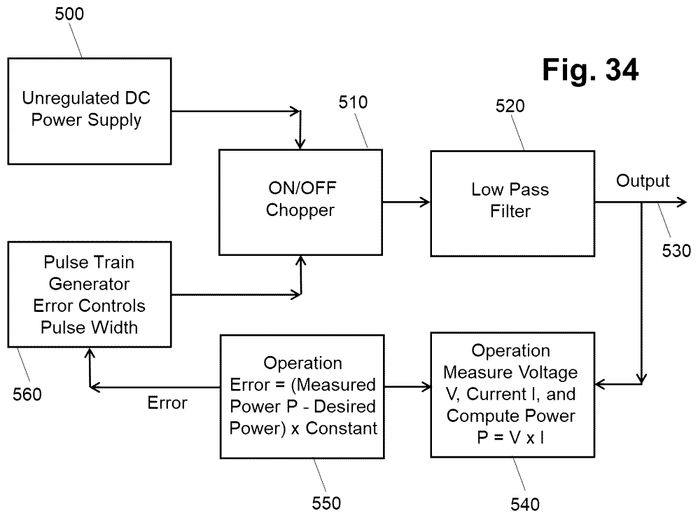

A direct current DC power supply could be either a constant voltage, constant current, or unregulated DC power supply. There are issues with any of these power supplies when the load resistance varies. Consequently, in this GED invention a constant power DC power supply, which is a variation of a constant current DC power supply, is used. This constant power DC power supply would have less issues with load variations than the other DC power supplies. FIG. 34 show a block diagram of its operation. The voltage of an Unregulated DC Power Supply 500 is turned on-and-off by a Chopper 510 using a pulse train obtained from the Pulse Train Generator 560. The Pulse Train Generator 560 generates a pulse train having a frequency in the tens of Kilohertz and a duty cycle varying from near zero to one. The output of the Chopper 510 is passed through a Low Pass Filter 520 and is output to the terminals 530 of the anode and cathode contained in the GED invention's electrodialysis stack. The voltage V and current I outputs of the Low Pass Filter 520 are measured and the Power P being delivered to the load is computed by P=V×I in Operation 540. In Operation 550, the Error is computed by subtracting the computed power P obtained in Operation 540 from the desired power and multiplying this valve by a constant. This Error controls the duty cycle in the Pulse Train Generator 560 using a negative servo feedback loop. For example, if the load requires more power to make the power level the same as the desired power, the error signal increases and the duty cycle increases until the desired power is reached where the error signal becomes zero and no more correction is required. The opposite occurs if the power is too high for the desired power and the error signal drives the duty cycle down until no more correction is required.

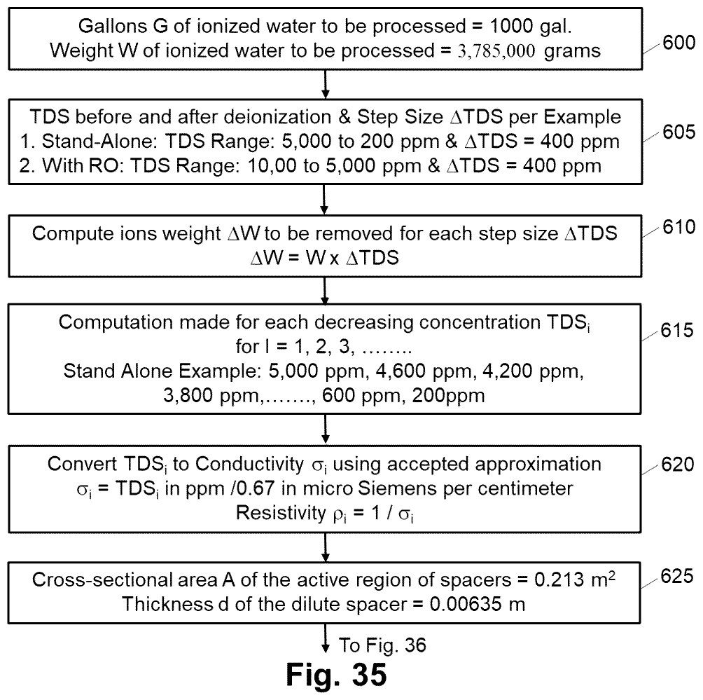

The performance of the GED invention using the design just described in relationship to all the previous figures for two different examples is given next. But first the process and equations used in performing the analysis is given in FIGS. 35 through 38. Referring to FIG. 35, the first step in 600 is to identify the volume and weight of the source feed water to be deionized. Next in Step 605, the range of TDS concentration in the aqueous solution from largest to smallest along with the decreasing step size in TDS are given for the two examples. Next the equation 610 is used to compute the ion weight ΔW removed for each step size ΔTDS. Next the computation 615 is made for each decreasing TDS concentration for each step in ΔTDS. Each TDS is converted to conductivity and the resistivity using the standard approximate formula in Step 620. Using the earlier given GED design described with aid of FIGS. 7 through 21, the cross-sectional area of the active open interior region of the Concentrate Water Spacers, Dilute Water Spacers, Anolyte Water spacers, and Catholyte Water Spacers is computed in Step 625. The dimensions of the active open interior region of the spacers are 11 inches wide and 30 inches tall. Furthermore, the Dilute Water Spacer's thickness is specified. A third example is also provided whose performance can be obtained from the performance of one of the examples without performing all the computations.

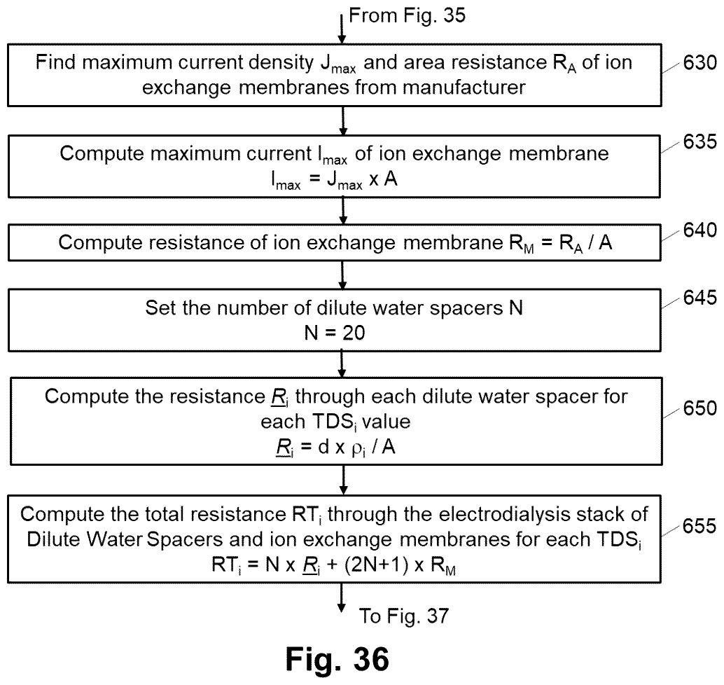

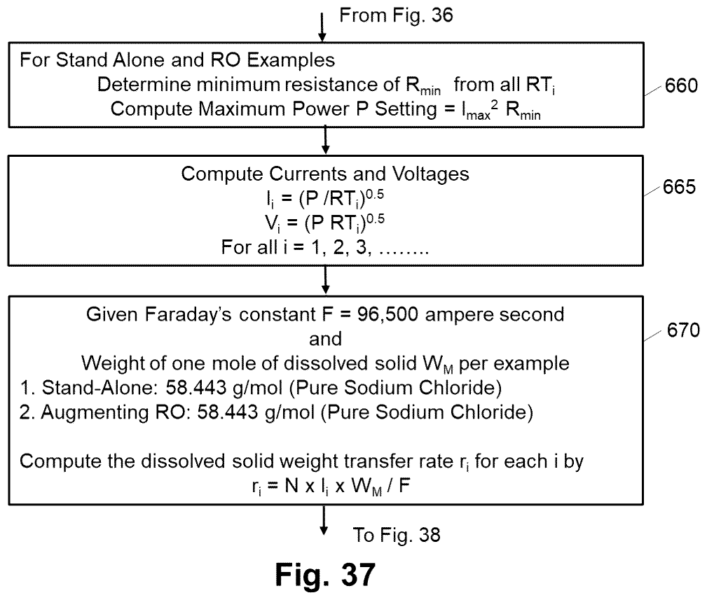

Referring to FIG. 36, the next Step 630 is to find the maximum current density and area resistance R_{A} of the ion exchange membranes from the manufacturer. From these values, the maximum allowed current for the ion exchange membranes is computed in Step 635 and the resistance of the ion exchange membranes is computed in Step 640. The number of Dilute Water Spacers N for the GED example design is set in Step 645. The electrical resistance Rᵢ through each Dilute Water Spacer for TDSᵢ value is computed in Step 650. The total resistance RTᵢ through the electrodialysis stack of Dilute Water Spacers and ion exchange membranes for each TDSᵢ value is computed in Step 655. Because of the very high TDS due to supersaturated concentrate water and near saturated anolyte and catholyte waters, the total electrical resistance through the Concentrate, Anolyte, and Catholyte Water Spacers is negligible compared to the total resistance through the electrodialysis stack of Dilute Water Spacers and Ion Exchange Membranes and therefore is ignored.

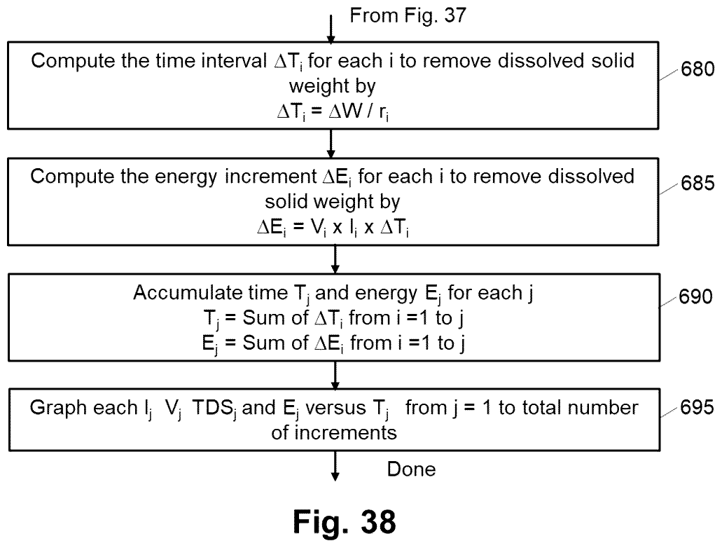

Referring to FIG. 37, determine minimum resistance Rₘᵢₙ from RTᵢ for all i and the maximum power setting P in Step 660. Using this maximum power P in Step 665, the currents Iᵢ and voltages Vᵢ for each total electrical resistance RTᵢ through the electrodialysis stack of the GED invention, that is associated with each value of TDS, are computed. In Step 670, the dissolved solid weight transfer rate rᵢ for each TDSᵢ valve is computed from the number of Dilute Water Spacers, current for that TDSᵢ value, weight of one mole of Sodium Chloride, and Faraday's constant.

Referring to FIG. 38, the time interval ΔTᵢ to remove the desired dissolved solid weight ΔW for each step value of TDSᵢ is computed using the desired weight ΔW and the rate of dissolved solid weight removal nᵢ for this time period ΔTᵢ as shown in Step 680. The increment of energy ΔEᵢ required to remove the desired dissolved solid weight ΔW for each step value of TDSᵢ is computed using the current Iᵢ, voltage Vᵢ, and time interval ΔTᵢ as shown in Step 685. In Step 690, the time Tⱼ and energy Eⱼ for each TDSᵢ step is accumulated and stored for each increment j. In Step 695, each value of current Iᵢ, voltage Vᵢ, TDSⱼ, and energy Eⱼ used are plotted versus time Tⱼ.

### Example 1

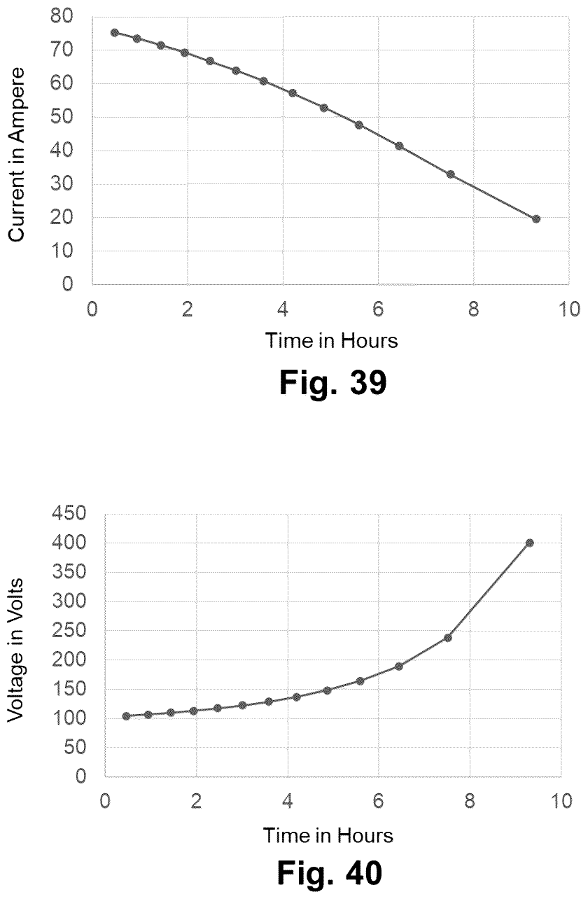

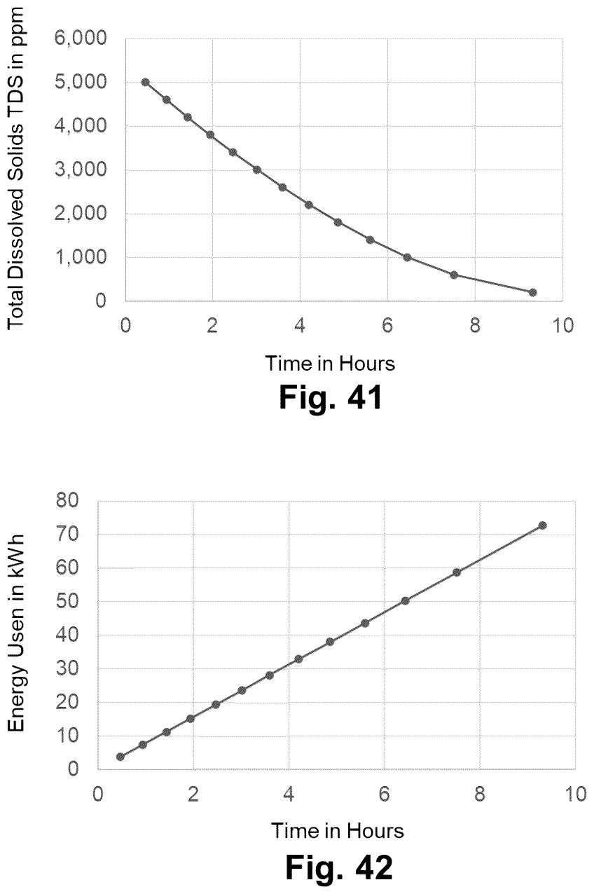

The performance of a Stand-Alone example of this invention's GED Unit using the design shown in FIGS. 7 through 34 and the analysis process provided in FIGS. 35 to 38 is described here. The requirement for the Stand-Alone example is to reduce the TDS of 1000 gallons of an aqueous Sodium Chloride solution from a TDS of 5000 ppm to 200 ppm. The maximum current density and area resistance of the ion exchange membranes are 400 ampere/m² and 0.003 ohms m² respectively. The other parameters of the design are provided in FIGS. 35 to 38. The Current, Voltage, TDS, and Energy Used are plotted versus time in FIGS. 39 to 42. Referring to Step 620 in FIG. 35 and Step 650 in FIG. 36, it is found that the electrical resistance through the dilute spacers increases as the TDS decreases. So as the electrical resistance through the electrodialysis stack increases as TDS decreases, the current must decrease as the TDS decreases to keep the power constant as shown in FIG. 39. Furthermore, the voltage must increase with decreasing TDS as time goes on to keep the power constant as shown in FIG. 40 given the decreasing current. FIG. 41 shows the decreasing TDS as a function of time. This curve is somewhat nonlinear because during the time of high current more ions are being transferred out of the Dilute Water Spacers than occurs during lower current conditions. FIG. 42 shows a linear increase in energy used which is linear because the power was adjusted to be constant. Finally using the data from FIGS. 41 and 42, the common metrics of Energy used per thousand Gallons of water desalinated and the rate of desalination in Gallons per hour for this example are 72 kWh per 1000 gallons desalinated and 108 Gallons desalinated per hour (1,000 gallons/9.2 hours) respectively. The way these metrics could be improved is to reduce the electrical resistance through the Dilute Water Spacers and the Anion and Cation Ion Exchange Membranes. The advantage of this example is that there would be desalination with only solid waste to dispose of, but at the cost of significant power required which is subsequently discussed.

The approximate amount of water used in forming the Hydrogen and Oxygen gases in the combined electrolysis operations in the Anolyte and Catholyte Water Spacers is approximated by the average current times the weight of one mole of water, which is 18 grams per mole, times the processing time divided by Faraday's Constant. For this Example 1, having an average current of about 48 amperes and processing time of (9.2 hours×3600 seconds/hours) from FIG. 39 is 300 grams of water used per 1000 gallons of source water desalinated. This small amount of anolyte and catholyte water needs to be replaced as time goes on. The energy required for the electrolysis process in the Anolyte and Catholyte Water Spacers was not included in the energy calculations in the previous paragraph and is computed as follows. First note that the theoretical minimum of 237 KJ (0.06583333 kWh) of electrical energy input required to dissociate each mole of water is 237 KJ (0.06583333 kWh) per mole. Therefore, the energy required for electrolysis is 0.06583333 kWh per mole times 300 grams of water disassociated divided by the weight of one mole of water which equal to 1.1 kWh for this Stand-Alone desalination example. This energy used was small and was not included in the energy used in this first example.

### Example 2

The second example operates the invention's GED Unit 1 to process the waste water from a Reverse Osmosis RO desalination process into a solid waste as shown in FIG. 43. The GED Unit 1 portion of the process is identical to that shown in FIG. 1 and its description is repeated. Rather than source water as before, now new waste water 10 to be reduced in TDS by the GED Unit 1 is transferred from RO Holding Reservoir & Pump 710 through Valve 735 to the Dilute Water Reservoir and Pump 2. The dilute water is circulated between the Dilute Water Reservoir and Pump 2 and the Gated Electrodialysis GED Unit 1. Concentrate water is circulated between the Concentrate Water Enhanced Clarifier and Pump 3 and the Gated Electrodialysis GED Unit 1. Electrolyte water is also circulated between the Electrolyte Water Reservoir & Pump 4 and the GED Unit 1. Hydrogen and Oxygen gases are vented 14 from the Electrolyte Water Reservoir & Pump 4. Precipitated solids 16 are periodically removed from the Concentrate Water Enhanced Clarifier and Pump 3. When the ions in the dilute water have been depleted to the desired level in the Dilute Water Reservoir and Pump 2, the dilute water in the Dilute Water Reservoir and Pump 2 is removed through 12 and sent to the Reverse Osmosis Reservoir & Pump 700 through valve 715 where it is combined with the feed water 720 to be desalinated. After the Reverse Osmosis Reservoir & Pump 700 has been filled, this water is passed through the Reverse Osmosis Unit 705 where part of the water is desalinated and output 725 and the other part that is waste water is sent to the RO Holding Reservoir & Pump 710. This entire process is then repeated.

An ideal example of the concentrations and volume of ionized waters at various locations in FIG. 43 is given as follow. A solution of 1,000 gallons of aqueous Sodium Chloride solution at a TDS concentration of 5,000 ppm is to be desalinated. In the Reverse Osmosis Reservoir & Pump 700, 1,000 gallons of dilute water consisting of aqueous Sodium Chloride solution with a TDS concentration of 5,000 ppm from the Dilute Water Reservoir and Pump 2 through valve 715 is added to the 1,000 gallons of aqueous Sodium Chloride solution at a TDS concentration of 5,000 ppm of feed water is to be desalinated. The Reverse Osmosis Reservoir & Pump 700 now has 2,000 gallons of concentrate water with a concentration of 5,000 ppm. Assuming a 50% RO system, 1,000 gallons of desalinated water is output for use and 1,000 gallons of waste water with a concentration of 10,000 ppm is sent to the RO Holding Reservoir & Pump 710, then on to the Dilute Water Reservoir and Pump 2 through valve 735. The GED Unit 1 reduces the 1,000 gallons of aqueous Sodium Chloride solution from a TDS concentration of 10,000 ppm to a TDS concentration of 5,000 ppm. At the same time supersaturated concentrate water is circulated between the GED Unit 1 and the Concentrate Water Enhanced Clarifier and Pump 3. After sufficient time has passed, Sodium Chloride salt ions precipitate out of the supersaturated concentrate water forming a solid in the Concentrate Water Enhanced Clarifier and Pump 3. The weight of the Sodium Chloride solid removed from the Concentrate Water Enhanced Clarifier and Pump 3 is approximately computed using the weight of one gallon of pure water of 3.78 kg/gal, approximate density of low salinity salt water of 1.0, 1,000 gallons of water, change in TDS concentration by the formula ((10,000 ppm−5,000 ppm)×1,000 gallons×1.0×3.78 kg/gal to be equal to 19 kg.

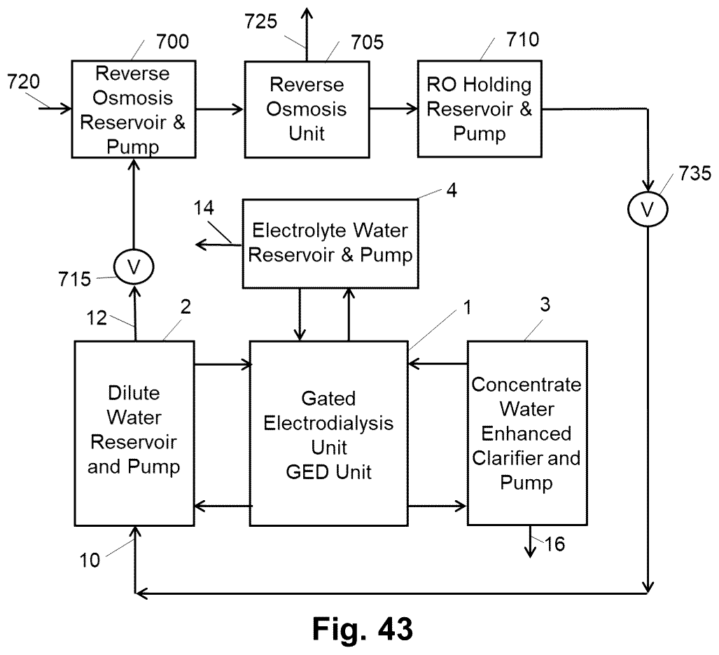

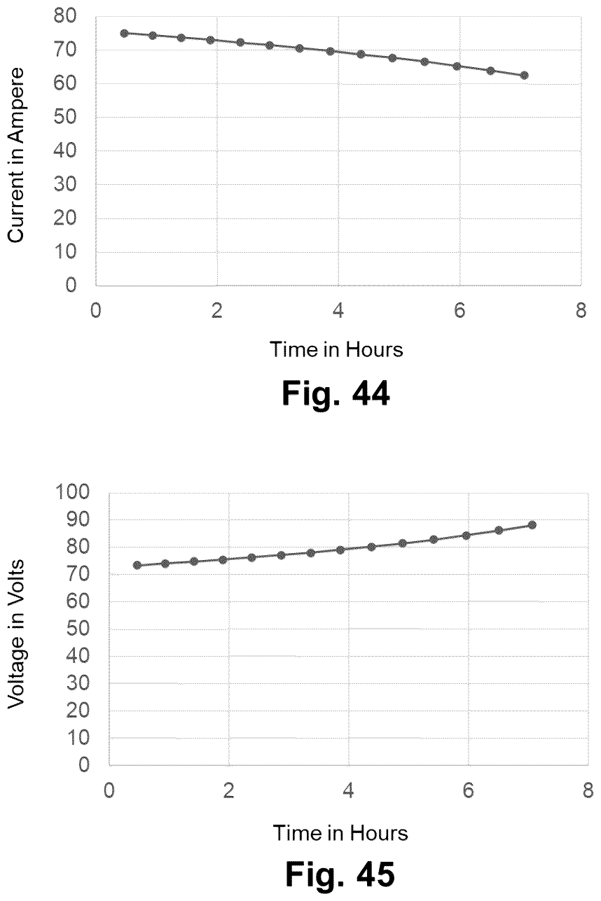

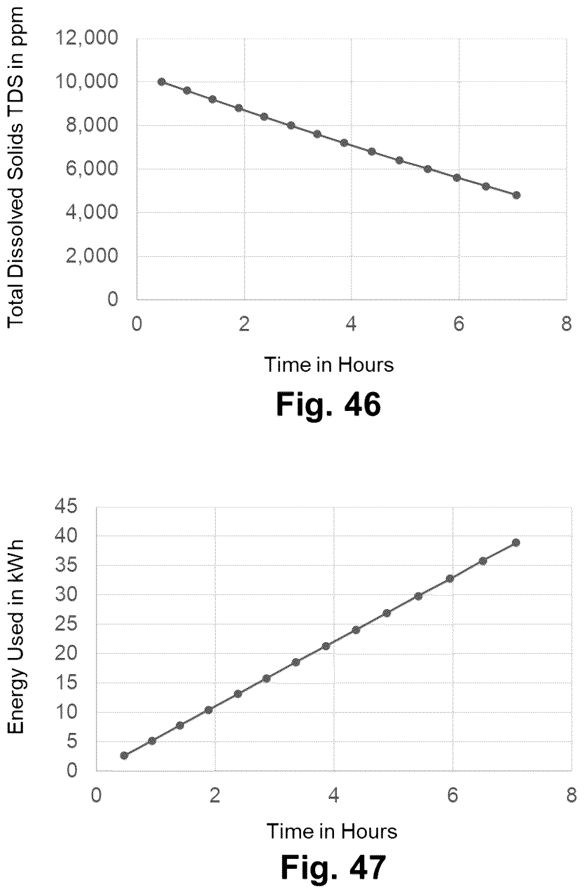

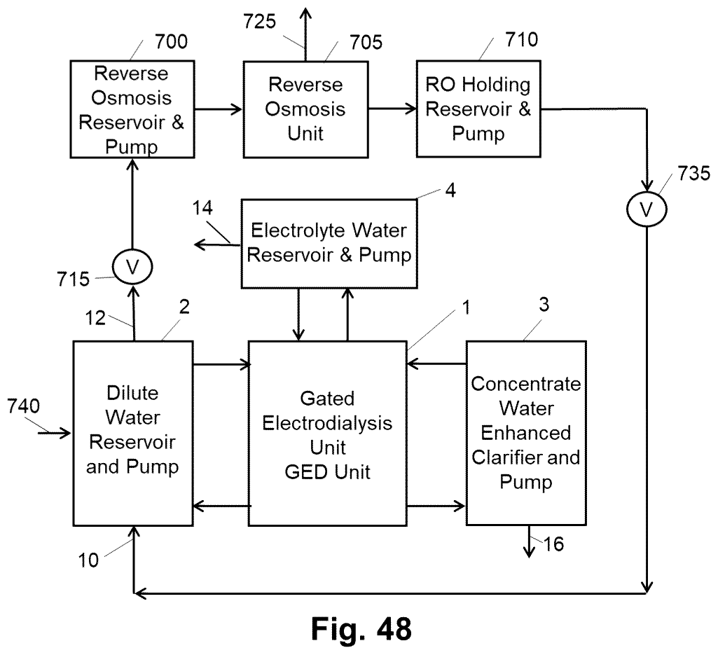

The performance of a GED unit augmenting a RO desalination unit is given next. Again, the invention's GED Unit using the design shown in FIGS. 7 to 34 and analysis process described in FIGS. 35 to 38 are used in the analysis. The requirement for the GED unit augmenting a RO desalination unit example is to reduce the TDS of a solution of 1000 gallons of aqueous Sodium Chloride solution from a TDS concentration of 10,000 ppm to 5,000 ppm. The maximum current density and area resistance of the ion exchange membranes are 400 ampere/m² and 0.003 ohms m² respectively. The other parameters of the design are provided in FIGS. 35 to 38. The Current, Voltage, TDS, and Energy used are plotted versus time in FIGS. 44 to 47. Referring to Step 620 FIG. 35 and Step 650 in FIG. 36, it is found that the electrical resistance through the Dilute Water Spacers increases as the TDS decreases. So as the electrical resistance through the electrodialysis stack increases, the current must decrease as a function of time as shown in FIG. 44. However, the current does not decrease by much because the electrical resistance through the spacers is fairly small relative to the constant electrical resistance through the ion exchange membranes. Since the power used is adjusted to remain constant, the voltage must increase with decreasing TDS as a function of time in order to keep the power constant as shown in FIG. 45 given the decreasing current. FIG. 46 shows the decreasing TDS as a function of time. This curve is almost linear because the current did not change by large amount over this time interval. FIG. 47 shows a linear increase in energy used because the power was adjusted to be constant. Finally using the data from FIGS. 46 and 47, the common metrics of Energy used per thousand Gallons of water desalinated and the rate of desalination in Gallons per hour for this example are 39 kWh per 1000 gallons desalinated and 143 Gallons desalinated per hour (1,000 Gallons/7 hour) respectively. The way these metrics could be improved is to mostly reduce the electrical resistance through the Anion and Cation Ion Exchange Membrane and to a lesser extent through the Dilute Water Spacers. The advantage of this example is that there would be desalination with only solid waste to dispose of, but at the cost of significant power required which is subsequently discussed. In addition, the complete process requires both a GED unit and an RO unit.

The approximation to the amount of water used in forming the Hydrogen and Oxygen gases in the combined electrolysis operations in the Anolyte and Catholyte Water Spacers is given by the average current times the weight of one mole of water times, which is 18 grams per mole, times the processing time divided by Faraday's Constant. For this Example 2, having an average current of about 70 amperes and processing time of (7.1 hours×3600 seconds/hours) from FIG. 44 is 330 grams of water used per 1000 gallons of source water desalinated. This small amount of water needs to be replaced as time goes on. The energy required for the electrolysis process in the Anolyte and Catholyte Water Spacers was not included in the energy calculations in the previous paragraph and is computed as follows. First note that the theoretical minimum of 237 KJ (0.06583333 kWh) of electrical energy input required to dissociate each mole of water is 237 KJ (0.06583333 kWh) per mole. Therefore, the energy required for electrolysis is 0.06583333 kWh per mole times 330 grams of water disassociated divided by the weight of one mole of water which equal to 1.2 kWh for this GED unit augmenting a RO desalination unit desalination example. This energy used was small and was not included in the energy used in this second example.

### Example 3

Another example of the use of the GED Unit with RO involves them sharing the desalination operation. FIG. 48 shows the configuration which is only different than the one given in FIG. 43 in where the feed water enters the system. In FIG. 48, the feed water 740 to be desalinated is brought into the Dilute Water Reservoir and Pump 2 where it is combined with the RO waste water 10 from RO Holding Reservoir & Pump 710 coming through Valve 735. The dilute water is circulated between the Dilute Water Reservoir and Pump 2 and the Gated Electrodialysis GED Unit 1. Concentrate water is circulated between the Concentrate Water Enhanced Clarifier and Pump 3 and the Gated Electrodialysis GED Unit 1. Electrolyte water is also circulated between the Electrolyte Water Reservoir & Pump 4 and the GED Unit 1. Hydrogen and Oxygen gases are vented 14 from the Electrolyte Water Reservoir & Pump 4. Precipitated solids 16 are periodically removed from the Concentrate Water Enhanced Clarifier and Pump 3. When the ions in the dilute water have been depleted to the desired TDS concentration level in the Dilute Water Reservoir and Pump 2, the dilute water in the Dilute Water Reservoir and Pump 2 is removed through 12 and sent to the Reverse Osmosis Reservoir & Pump 700 through valve 715 where it is to be desalinated. After the Reverse Osmosis Reservoir & Pump 700 has been filled, this water is passed through the Reverse Osmosis Unit 705 where part of the water is desalinated and output 725 and the other part that is waste water is sent to the RO Holding Reservoir & Pump 710. This entire process is then repeated.

An ideal example of the concentrations and volume of ionized waters at various locations in FIG. 48 is given as follow. A solution of 1,000 gallons of aqueous Sodium Chloride solution at a TDS concentration of 5,000 ppm is the feed water to be desalinated. This feed water is added to the RO waste water from the 1,000 gallons of waste water with a concentration of 5,000 ppm from the RO Holding Reservoir & Pump 710 to give 2,000 gallons of dilute water at a concentration of 5,000 ppm. The dilute water is reduced to a concentration of 2,500 ppm using the GED Unit and sent to the Reverse Osmosis Reservoir & Pump 700. These 2,000 gallons at a concentration of 2,500 ppm is passed through the RO Unit which provides 1,000 gallons of desalinated water and 1,000 gallons waste water at a concentration 5,000 ppm. The process is then repeated. At the same time supersaturated concentrate water is circulated between the GED Unit 1 and the Concentrate Water Enhanced Clarifier and Pump 3. After sufficient time has passed, Sodium Chloride salt ions precipitate out of the supersaturated concentrate water forming a solid in the Concentrate Water Enhanced Clarifier and Pump 3. Using the same formula as used in Example 2, the weight of the Sodium Chloride solid removed from the Concentrate Water Enhanced Clarifier and Pump 3 is ((5,000 ppm−2,500 ppm)×2,000 gallons×1.0×3.78 kg/gal) equal to 19 kg.

The performance of example 3 could be obtained in the same manner as the other examples. However, the results from Example 1 can be used as well. From Example 1, it takes about 3.8 hours to reduce the TDS concentration from 5,000 ppm to 2,500 ppm for 1,000 gallons and about 30 kWh of electrical power for 1,000 gallons of feed water. The GED Unit in Example 3 is the same as Example 1 except that there is 2,000 rather than 1,000 gallons to process with the GED. So, the total time to desalinate with the GED in Example 3 is twice the 3.8 hours and consequently the energy used is twice the 30 kWh. So, the common metrics for Example 3 are Energy used per thousand Gallons of water desalinated and the rate of desalination in Gallons per hour are 60 kWh per 1000 gallons desalinated and 132 Gallons desalinated per hour respectively. Comparing Examples 2 and 3, Example 2 GED Unit desalination Energy used is less than Example 3 but the RO Energy used is higher and vice versa Example 3 GED Unit energy used is higher than Example 2 but its RO energy used is lower. In both cases the waste is solid.

The last important part of this invention is to discuss the precipitation of the ions from the supersaturated ion-water solution into solids. For both examples, assume the worst case when the current is at a maximum of 75 amperes for the three examples and the time that the Concentrate Water Pump is OFF leaving the Concentrate Water stationary in the Concentrate Spacer for one hour. The weight of ions transferred into a single Concentrate Water Spacer for one hour is given by the current times the weight of one mole of Sodium Chloride times one hour divided by Faraday's constant which is 162 grams for the examples. The TDS concentration of the concentrate water in the single Concentrate Water Spacer after that one hour is found next. First the volume of the single Concentrate Water Spacer is found to be 0.0067 m³ (1.77 gallons). Then the initial weight of the salt water in the single Concentrate Water Spacer is computed by 1.77 gallons times 3.79 kg/gallon times density of the aqueous Sodium Chloride solution, which is 1.2. By this formula, the initial weight for this example is found to be 8 kg. Since the aqueous Sodium Chloride solution has a TDS concentration of 280,000 ppm, the weight of the salt ions in the single Concentrate Water Spacer is 0.28 times 8 kg which is equal to 2.24 kg. So, the TDS concentration of the aqueous Sodium Chloride solution after one hour is given by (2.24+0.162) kg divided by (8+0.162) kg which is equal to 294,291 ppm and therefore the solution is slightly supersaturated. During this one hour of time that the aqueous Sodium Chloride solution is being supersaturated, there can be small amounts of solids precipitate out from the solution. After one hour only 162 grams (6 oz) of solids at most can be precipitated out in the 1.77 gallons of aqueous Sodium Chloride solution which can easily be carried away with the supersaturated aqueous Sodium Chloride solution being sent to the Enhanced Clarifier's input as new saturated concentrate water is pumped into the single Concentrate Water Spacer from the Enhanced Clarifier's output.

Observing the Concentrate Water Enhanced Clarifier and Pump in FIGS. 5 and 6, the supersaturated aqueous Sodium Chloride solution, which may contain small amounts of precipitated out solids, enters on the right side 72, passes through the Enhanced Clarifier 61 and exits on the top left side 63. The volume transfer rate of moving water through the Enhanced Clarifier 61 is given by number of gallons of concentrate water removed from each Concentrate Water Spacer (1.77 gallons) times the number of spacers (20) divided by (1 hour) which is 35 Gallons per hour. The time it takes for concentrate water to pass through the Enhanced Clarifier 61 is given by the 700 gallons of water in the Enhanced Clarifier 61 divided by the volume transfer rate of 35 Gallons per hour of moving water through the Enhanced Clarifier 61 which results in 20 hours. During this time, the solids have time to precipitate out and drift to the bottom of the Enhanced Clarifier 61 and/or precipitate on to the macro crystals held in the perforated trays 82 in FIG. 6 where they can be periodically removed. This example is the same as the example given earlier when FIGS. 5 and 6 was discussed where a significantly more elaborate description of the Enhanced Clarifier process is provided.

This GED invention can be scaled to be larger or smaller. For example, if the GED invention's height is doubled, the width tripled and its thickness increases by 3/2. The flow rate from GED augmenting the RO process by processing its waste water to solids would be 9 time 143 Gallons per hour which is 1287 gallons per hour or about 31,000 gallons per day. If there are 1,000 units, then there would be 31 million gallons of water per day desalinated with only ZLD waste. A small Stand-Alone GED unit, that is about 9 times smaller in overall size would provide about 300 gallons a day which is computed by 108 gallons per hour times 24 hours divided by 9, for a residential application.

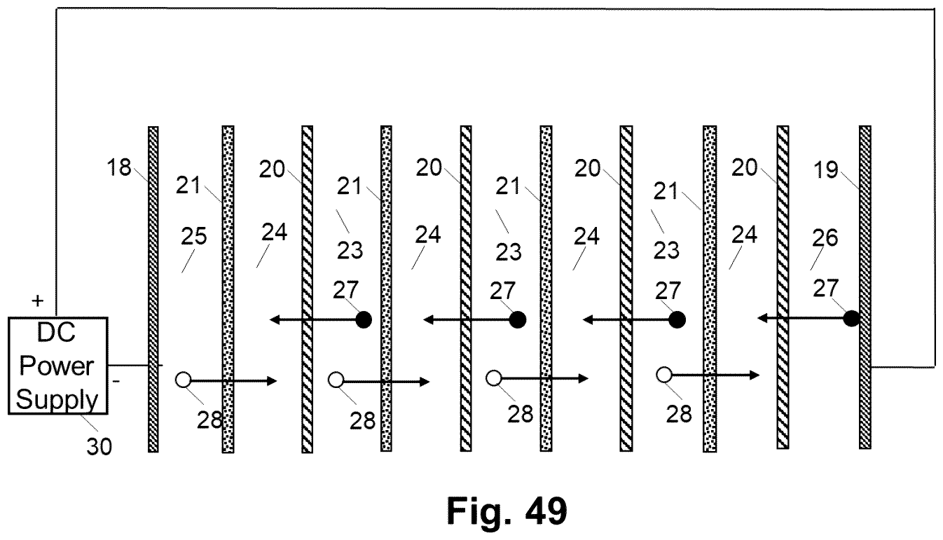

FIG. 49 illustrates another way the electrodialysis stack can be constructed. In this construction an Anion Ion Exchange Membrane is inserted next to the catholyte water space followed by another concentrate water space to the usual electrodialysis stack that was previously illustrated in FIGS. 2 and 3. Specifically, the left inert cathode electrode 18 is attached to the negative terminal of a Direct Current DC Power Supply 30 which can gated on-and-off with a Power Controller. The right inert anode electrode 19 is attached to the positive terminal of the DC Power Supply 30. Next to the inert cathode and anode electrodes 18 and 19, there are spaces 25 and 26 for the catholyte and anolyte waters to flow respectively. Adjacent to the catholyte water space 25 on the left is an Anion Ion Exchange Membrane 21 followed by a concentrate water space 24. Next on the left is a Cation Ion Exchange Membrane 20 followed by a space for dilute water to flow 23. Next to this first dilute water space 23 on the left, there is an Anion Ion Exchange Membrane 21 followed by a space for concentrate water 24 to flow. The sequence of Anion Ion Exchange Membrane 21, concentrate water 24, Cation Ion Exchange Membrane 20, dilute water 23 is repeated from left to right until the Cation Ion Exchange Membrane 20 nearest the anolyte water space 26 nearest the right anode electrode 29 is reached. Given the DC Power Supply 30 is gated on, the cations 27 flow from right to left from waters on the right side of the Cation Ion Exchange Membranes 20 to waters on the left side of it. The anions 28 flow from left to right from waters on the left side of the Anion Ion Exchange Membrane 21 to waters on the right side of it. The anions cannot flow through the Cation Ion Exchange Membrane and the cations cannot flow through the Anion Ion Exchange Membrane. Thus, ions flow out of dilute water spaces 23 and into the concentrate water spaces 24 except at each end where on the right cations flow out of the anolyte water space 26 into the concentrate water 24 nearest the anolyte water space 25 and on the left anions flow out of the catholyte water space 25 to the concentrate water space 24 nearest the catholyte water space 25.

Consequently, this process is called desalination because the ions are being transferred from the dilute water to the concentrate water. The advantage of this electrodialysis stack arrangement is that ions only flow out of the anolyte and catholyte waters so they cannot be contaminated with a variety of cation ions like what happens in the common electrodialysis arrangement shown in FIGS. 2 and 3. However, negative to this feature, the ions in the electrolyte water are being lost to the concentrate water and must be periodically replaced.

Using the alternate arrangement of components for electrodialysis operation that is shown in FIG. 49, the electrodialysis stack can be constructed using the same type of components previously shown that used a conventional arrangement. For convenience, the sub-assemblies are defined as: (1) a cathode assembly is defined as a sequence of Compression Plate, Cover, Catholyte Water Spacer, Anion Ion Exchange Membrane, and Concentrate Water Spacer, (2) an anode assembly is defined as a sequence of Cation Ion Exchange Membrane, Anolyte Water Spacer, Cover, and Compression Plate, and (3) a middle assembly is defined as a repeating sequence of Cation Ion Exchange Membrane, Dilute Water Spacer, Anion Ion Exchange Membrane, and Concentrate Water Spacer. Then an alternate electrodialysis stack is defined as a stack of cathode, middle, and anode assemblies.

Finally, the outstanding features of this GED invention are:
1. There is essentially no leakage current and associated power loss in any of the dilute, concentrate, and electrolyte/anolyte/catholyte water distribution systems even when the concentrate ion-water solution is supersaturated and the dilute water can be of any ion concentrations including very low values.
2. There is no cross-water leakage between any of the dilute, concentrate, and electrolyte/anolyte/catholyte water distribution systems.
3. The concentrate water motion through an enhanced clarifier can be made very slow and thus take as much time as on the order of tens of hours so that there is ample time for the supersaturated concentrate water to precipitate solids onto seed crystals or directly precipitate solids and fall to the bottom of an enhanced reasonably compact clarifier.

1. This invention performs Zero Liquid Discharge ZLD electrodialysis using a modified electrodialysis unit called a Gated Electrodialysis GED unit, an Enhanced Clarifier, and other common ancillary equipment, which can operate when the concentrate water is supersaturated, but below the ion concentrations where spontaneous precipitation can occur.

2. The GED unit in-part contains Concentrate Water Spacers consisting of:
construction from a flat rectangular shaped block of non-electrical conducting material that is on-the-order of twenty to eighty-inches high, on-the-order of ten to forty-inches wide, and on-the-order of one and one-fourth-inch thick which has material removed from each one forming (1) Empty Space Regions, (2) Recessed Spaces Leaving Islands Regions, and (3) Holes,
Small Empty Space Regions are on-the-order of a Concentrate Water Spacer width minus two-inches wide and on-the-order of one-inch tall, where one Open Space Region is centered in the width dimension and located on-the-order of one-inch from the bottom of each Concentrate Water Spacer and the other Open Space Region is centered in the width dimension and located on-the-order of one-inch from the top of each Concentrate Water Spacer,
Recessed Spaces Leaving Islands Regions are on-the-order of a Concentrate Water Spacer width minus two-inches wide, on-the-order of the diameter of a flange of a Flanged Connector high where each Recessed Space Leaving Islands Region is centered in the width dimension and one set of back-to-back ones are located adjacent to the lower Small Empty Space and the other set of back-to-back ones are located adjacent to the upper Small Empty Space Region,
one Large Empty Space region is on-the-order of a Concentrate Water Spacer width minus two-inches wide, centered in the width dimension, and located between the lower and upper back-to-back Recessed Space Leaving Islands Regions,
in both the lower and upper Recessed Spaces Leaving Islands Regions, material is removed on both the front and back sides of the original flat rectangular material to form recessed areas on the front and the back that are each on-the-order of one-half-inch deep, leaving multiple islands on the front and back where each island's face has a size on-the-order of the size of the face of the flange on a Flanged Connector,
the material left between the front and back recessed areas in the lower and upper Recessed Spaces Leaving Islands Regions is on-the-order of one-fourth-inch thick,
the islands on the front and back of the Recessed Spaces Leaving Islands Regions are aligned with each other from front to back and on the back and on the front, they are on-the-order of one-half-inch apart as well as from the edges of the Recessed Spaces Leaving Islands Region,
hole in the center of each island is on-the-order of one and one-half-inch in diameter and is used to house Flanged Connectors that pass dilute water through them,
given flexible ion exchange membranes, on-the-order of one sixteenth of an inch can be shaved off the tops of the islands so that the flange of a Flanged Connector can be better accommodated,
external inlet concentrate water port hole housing a water fitting at the bottom of each Concentrate Water Spacer,
external outlet concentrate water port hole housing a water fitting at the top of each Concentrate Water Spacer,
When the concentrate water spacer is installed in the electrodialysis stack, concentrate water enters the external inlet concentrate water port at the bottom of a Concentrate Water Spacer, flows into the lower Small Empty Region, over the front and back recessed areas and around the front and back islands in the lower Recessed Space Leaving Islands Region, through the Large Empty Region, over the front and back recessed areas and around the front and back islands in the upper Recessed Space Leaving Islands Region, into the upper Small Empty Region, and out the external outlet concentrate water port at the top of the same Concentrate Water Spacer. Dilute water will pass through Flanged Connectors that are present in the holes in the islands.

3. The GED unit in-part contains an Anolyte Water Spacer and a Catholyte Water Spacer, which are identical in structure, consisting of:
in-part, construction from a flat rectangular shaped block of non-electrical conducting material that is the same height and width as the Concentrate Water Spacer in claim [2] and on-the-order of one and one-fourth-inch thick which has material removed from them forming a (1) Recessed Space Leaving Islands Region, and (2) Holes,
Recessed Space Leaving Islands Region whose dimensions are on-the-order of a Concentrate Water Spacer width minus two-inches wide, a Concentrate Water Spacer height minus two-inches high and is centered and located only on the front sides of the Anolyte and Catholyte Water Spacers,
in the Recessed Space Leaving Islands Region, material is removed on the front of the original flat rectangular block to form the recessed area leaving multiple islands where each island is identical in shape and have the same relative position as the islands on the front of the Concentrate Water Spacers except their height is the depth of the recessed area in the Anolyte and Catholyte Water Spacers, which is on-the-order of one-inch,
holes in the center of each island is of the same size and has the same relative positions as the holes in the islands in the Concentrate Water Spacer which are used to house Flanged Connectors which pass dilute water through them,
given flexible ion exchange membranes, on-the-order of one sixteenth of an inch can be shaved off the tops of the islands so that the flange of a Flanged Connector can be better accommodated,
an Inert Electrode, which is on-the-order of one-eighth of an inch thick and fits in the recessed area between the lower and upper islands at the back of the recessed area located on the front of the Anolyte and Catholyte Water Spacers, is inserted,
an Inert Electrode Connector that attaches to the back of the Inert Electrode, passes through a hole in the rear of the Anolyte and Catholyte Water Spacers, and protrudes beyond the rear of the Anolyte and Catholyte Water Spacers,
external inlet electrolyte water port hole housing a water fitting at the bottom of each Anolyte and Catholyte Water Spacer,
external outlet electrolyte water port hole housing a water fitting at the top of each Anolyte and Catholyte Water Spacer,
electrolyte water near the Inert Electrode that is attached to the positive terminal of a DC power supply is defined as anolyte water and this Inert Electrode is defined as the Anode and the electrolyte water near the Inert Electrode that is attached to the negative terminal of a DC power supply is defined as catholyte water and this Inert Electrode is defined as the Cathode, and
When the anolyte or catholyte water spacer is installed in the electrodialysis stack, electrolyte water enters the external inlet electrolyte water port at the bottom of each Anolyte and Catholyte Water Spacer, flows into the Recessed Space Leaving Islands Region and first into the entry recessed area, around the lower islands located in the recessed area, over the Inert Electrode residing in the recessed area, around the upper islands located in the recessed area, through the remaining recessed area, and out of the external outlet electrolyte water port at the top of each Anolyte and Catholyte Water Spacer. Dilute water will pass through Flanged Connectors that are present in the holes in the islands.

4. The GED unit in-part contains two Covers consisting of:
construction from a flat rectangular shaped block of non-electrical conducting material that has the same height and width as the Concentrate Water Spacer in claim [2] and on-the-order of one and one-fourth-inch thick which has material removed from each one forming (1) Recessed Space Regions, and (2) Holes,
Recessed Space Regions have on-the-order of one-inch-deep recessed areas only on the front of the Covers and have the same height, width, and relative locations as the Recessed Spaces Leaving Islands Regions of the Concentrate Water Spacer described in claim [2],
on-the-order of a one-half-inch hole on the face of the Cover at the same relative location as the hole for the Inert Electrode Connector in claim [3] and is used for the Inert Electrode Connector to protrude through it,
external inlet dilute water port hole housing a water fitting at the bottom of each Cover,
external outlet dilute water port hole housing a water fitting at the top of each Cover, and
When either an Anolyte Water Spacer or Catholyte Water Spacer containing their Flanged Connectors with gaskets is installed next to the Cover, dilute water enters the external inlet dilute water port, flows into the lower Recessed Space Region, and into Flanged Connectors housed in either an Anolyte or Catholyte Water Spacer that protrude into the lower Recessed Space Region
When either an Anolyte Water Spacer or Catholyte Water Spacer containing their Flanged Connectors with gaskets is installed next to the Cover, dilute water flows into the upper Recessed Space Region from Flanged Connectors housed in either an Anolyte or Catholyte Water Spacer that protrude into the upper Recessed Space Region and out of the external outlet dilute water port hole.

5. The GED unit in-part contain Flanged Connectors consisting of:
constructed from non-electrical conducting material or material with non-electrical conducting surfaces,
Flanged Connectors have a cylindrical portion and a flange portion,
diameter of the cylindrical portion of the Flanged Connectors is slightly less than the diameter of the holes in the Islands in the Concentrate, Anolyte, and Catholyte Water Spacers and Covers so the Flanged Connectors will just fit in these holes in the Concentrate, Anolyte, and Catholyte Water Spacers,
flange portion has a diameter on-the-order of one-inch larger than the diameter of the cylindrical portion of the Flanged Connectors and its thickness is on-the-order of one sixteenth of an inch,
observing the end of the cylindrical portion, there are holes in the ends that are completely through the Flanged Connectors,
center hole is threaded to accept a Threaded Rod and the remaining holes are used to pass dilute water through them, and
height of the Flanged Connectors is such that when they are inserted into holes on each side of an assembly of various required combinations of Dilute, Concentrate, Anolyte, and Catholyte Water Spacers, Anion and Cation Ion Exchange Membranes, and associated gaskets, there is only a small space on-the-order of one-fourth-inch between the two facing Flanged Connectors.

6. The GED unit in-part contains an Electrodialysis Stack consisting of:
in-part, Anion and Cation Ion Exchange Membranes, that have the same height and width as the Concentrate Water Spacer but with a thickness on the order of twenty mils and have holes in them of the same size and relative locations as those holes through the Islands in the Concentrate Water Spacer as described in claim [2],
in-part, Dilute Water Spacers are constructed from a flat rectangular shaped block of non-electrical conducting material that have the same height and width as the Concentrate Water Spacer but with a thickness typically between one-eighth to one-fourth inch when compressed with Dilute Water Gaskets and has a centered open space whose width is on-the-order of the Dilute Water Spacer width minus two-inches and its height is on the order of the Dilute Water Spacer height minus two-inches,
in-part, Dilute Groups consisting of a stack of a Dilute Water Gasket, Dilute Water Spacer, and Dilute Water Gasket,
in-part, Concentrate Groups consisting of Flanged Connectors screwed into Threaded Rods that are inserted into the holes associated with the islands on the one side of a stack of components consisting of a Anion Ion Exchange Membrane, combination of a Flanged Connector Gasket and Concentrate Water Gasket, Concentrate Water Spacer, combination of a Flanged Connector Gasket and Concentrate Water Gasket, and Cation Ion Exchange Membrane and having other Flanged Connectors inserted into holes associated with the islands and screwed onto the threaded Rods on the other side of the same stack of components,
in-part, a Cathode Group consisting of Flanged Connectors screwed into Threaded Rods that are inserted into the holes associated with the islands on one side of a stack of components consisting of a Catholyte Water Spacer, combination of a Flanged Connector Gasket and Catholyte Water Gasket, and Cation Ion Exchange Membrane and having the other Flanged Connectors inserted into holes associated with the islands and screwed onto the Threaded Rods on the other side of the same stack of components where cations flow into the Catholyte Water Spacer,
in-part, an Anode Group consisting of Flanged Connectors screwed into Threaded Rods that are inserted into the holes associated with the islands on one side of a stack of components consisting of an Anolyte Water Spacer, combination of a Flanged Connector Gasket and Anolyte Water Gasket, Cation Ion Exchange Membrane, combination of a Flanged Connector Gasket and Concentrate Water Gasket, Concentrate Water Spacer, combination of a Flanged Connector Gasket and Concentrate Water Gasket, and Anion Ion Exchange Membrane and having the other Flanged Connectors inserted into holes associated with the islands and screwed onto the Threaded Rods on the other side of the same stack of components where cations flow out of the Anolyte Water Spacer,
when the Flanged Connector pairs having a Threaded Rod screwed into each of them and which are located in the Concentrate, Cathode, and Anolyte Groups, are turned, the assemblies are compressed together near the hole locations in the assemblies between each Flanged Connector pair to prevent interior water leaks,
in-part, two Cover Groups each consisting of a Cover Gasket located next to a Cover,
in-part, two Compression Plates made of strong metals that are at least two-inches taller as well as two-inches wider than the Concentrate, Cathode, and Anode Groups as well as the Cover Groups and are on-the-order of one-half-inch thick,
Compression Plates have holes near their perimeter for threaded rods to pass through them for the purpose of compressing the Electrodialysis Stack together plus a hole in their center to allow access to the Electrode Connector, and
Electrodialysis Stack is composed of a stack of components consisting of a Compression Plate, Cover Group, Cathode Group, multiple alternating Dilute and Concentrate Groups, Anode Group, Cover Group, and Compression Plate which are compressed together using Threaded Rods through the holes in the Compression Plates near their perimeters which are then secured with nuts.

7. The dilute water distribution system operation and property consists of:
dilute water flows from a Dilute Water Reservoir and Pump into one of the Covers from below and then it travels through the lower holes in the Concentrate, Anode, and Cathode Groups of the electrodialysis stack as well as upward in each Dilute Water Spacer where it then flows through all the upper holes in the Concentrate, Anode, and Cathode Groups of the electrodialysis stack and out of the top of the Cover at the other end of the electrodialysis stack, and
because all the Concentrate, Anode, and Cathode groups of components of the electrodialysis stack are compressed together at each of their internally contained lower and the upper hole positions with Flange Connectors, there is no internal water leaks in the electrodialysis stack.

8. The concentrate water distribution system construction and properties consist of:
when the concentrate water pump is on, concentrate water flows from a Concentrate Water Enhanced Clarifier and Pump through a Manifold that distributes the water to multiple opened Valves to the bottom of each of the Concentrate Water Spacers, through the Concentrate Water Spacers, from the tops of the Concentrate Water Spacers through multiple tubes to the Concentrate Water Container situated above the Concentrate Water Spacers where all the concentrate waters are combined, and finally returned to the Concentrate Water Enhanced Clarifier and Pump,
there is one Valve for each one of the Concentrate Water Spacers,
there is one tube for each one of the Concentrate Water Spacers,
when the concentrate water pump is off and all the Valves are closed, the concentrate water distribution system has the property of trapping the concentrate water in each of the Concentrate Water Spacers and tubes leading from them to the Concentrate Water Container and consequently these trapped concentrate waters are all stationary,
when the concentrate water pump is off and all the Valves are closed, the concentrate water trapped above each Valve is electrically isolated from the trapped concentrate water above any other Valve which can be achieved by using electrically isolated valves or draining the concentrate water on the feed side of the Valve and using plastic water feeds to the Valve,
when the concentrate water pump is off and the Valves are closed, the Concentrate Water Container drains the concentrate water from it leaving exposed tubes above any residual water left in the Concentrate Water Container and consequently there is no physical or electrical connection between any concentrate water in any of the tubes along with the associated Concentrate Water Spacers,
the final combined effect of the concentrate water distribution system is when the concentrate pump is on, the concentrate water can completely circulate through its distribution system, and when the concentrate water pump is off, the concentrate water in each Concentrate Water Spacer is stationary and electrically isolated from the concentrate water in all the other Concentrate Water Spacers, and
an option to using one Valve for each Concentrate Water Spacer after the Concentrate Water Manifold is to use only one Valve before the Concentrate Water Manifold but no Valves after the Concentrate Water Manifold which is applicable only when the dilute water has high enough conductivity and the electrical resistance through the ion exchange membranes is such that there is only a small current and associated power loss in the concentrate water distribution system when DC electrical power is applied to the electrodes and desalination is being performed.

9. The electrolyte water distribution system construction and properties consist of:
when the electrolyte water pump is on, electrolyte water flows from an Electrolyte Water Reservoir and Pump through a Manifold that distributes the water to two opened Valves to the bottom of each of the Anolyte and Catholyte Water Spacers, through the Anolyte and Catholyte Spacers, from the tops of the Anolyte and Catholyte Water Spacers through two tubes to the Electrolyte Water Container situated above the Anolyte and Catholyte Water Spacers where the electrolyte waters are combined, and finally returned to the Electrolyte Water Reservoir and Pump,
when the electrolyte water pump is off and all the Valves are closed, the Electrolyte Water Container has the property of trapping the electrolyte water in each tube along with the associated Anolyte and Catholyte Water Spacers situated below them and consequently the trapped electrolyte waters are all stationary,
there is one Valve for each one of the Anolyte and Catholyte Water Spacers,
there is one tube for each one of the Anolyte and Catholyte Water Spacers,
when the electrolyte water pump is off and the Valves are closed, the electrolyte water trapped above one Valve is electrically isolated from the electrolyte water trapped above the other Valve which can be achieved by using electrically isolated valves or draining the electrolyte water on the feed side of the Valves and using plastic water feeds to the Valve,
when the electrolyte water pump is off and the Valves are closed, the Electrolyte Water Container drains the electrolyte water from it leaving exposed tubes above any residual water left in the Electrolyte Water Container and consequently there is no physical or electrical connection between any electrolyte water in the two tubes along with the associated Anolyte and Catholyte Water Spacers, and
the final combined effect of the electrolyte water distribution system is when the electrolyte pump is on, the electrolyte water can completely circulate through its distribution system, and when the electrolyte water pump is off, the electrolyte waters in the Anolyte and Catholyte Water Spacers called anolyte and catholyte waters are stationary and electrically isolated from each other.

10. A Constant Power Direct Current DC Power Supply consists of:
unregulated DC power supply,
pulse width modulation chopping circuit,
low pass filter,
measurement of output voltage and current of the Constant Power Direct Current DC Power Supply
error computation between the desired power and computed power of voltage times the current, and
negative servo feedback loop that adjusts the pulse width that drives the error to zero so that the measured power is the same as the desired power.

11. The GED unit consists of:
Electrodialysis Stack described in claim [6] which in turn is made up in part with assemblies described in claims [2], [3], [4], and [5],
dilute water distribution system described in claim [7],
concentrate water distribution system described in claim [8],
electrolyte water distribution system described in claim [9],
Constant Power Direct Current DC Power Supply in claim [10], and
Power Controller with a timer and relay to (1) gate the Constant Power DC Power Supply ON while the concentrate water pump and electrolyte water pump are OFF and (2) gate the Constant Power DC Power Supply OFF while the concentrate water pump and electrolyte water pump are ON.

12. An Enhanced Clarifier consists of a tank that holds a supersaturated ion-water solution that reduces the ion concentration of a supersaturated ion-water solution by the precipitation of ions into solids which can be separated and removed from the concentrate ion-water solution as the supersaturated ion-water solution slowly moves from its input to its output and consists of at least one, combination of, or all the operational enhancements of:
with supports such as use of a perforated container or netting, multiple macroscopic seed crystals of various types are suspended in the Enhanced Clarifier where each seed crystal type has the same pairing of ions found in a supersaturated state in the concentrate water,
means of removing the supported enlarged suspended seed crystals that have grown in size due to precipitation and replacing them with smaller sets of suspended seed crystals,
add microscopic sized crystals of various types composed of the same pairing of ions found in a supersaturated state in the concentrate water so as to initiate and promote crystal growth from precipitation,
means of removing the crystals that have grown and fallen to bottom of the Enhanced Clarifier,
addition of a chemical where one ion type from the added chemical and one ion type from the supersaturated concentrate water will precipitate to a solid,
altering pH of the concentrate water,
increasing the temperature of the concentrate water entering the Concentrate Water Spacers to enhance its ion solubility and decrease temperature of the concentrate water in the Enhanced Clarifier to improve its precipitation,
vibration or stirring disturbances to enhance crystal formation and growth,
introduction of rough surfaces and scratches on multiple panels inserted into the Enhanced Clarifier, and
addition of particulate matter to reduce any static charge on the crystals and to enhance their ability to adhere together to improve their growth in size and weight.

13. When the GED unit is gated to its OFF state from its ON state, the conditions of the GED unit, Enhanced Clarifier, and common ancillary equipment are:
OFF state lasts on-the-order of 2 to 5 minutes in time,
no electrical power is delivered to the Inert Electrodes contained in the Anolyte and Catholyte Spacers,
dilute water is circulated through the GED and the in-part ancillary equipment consisting of dilute water reservoir and pump,
electrolyte water is circulated through the GED and the in-part ancillary equipment consisting of electrolyte water reservoir and pump,
concentrate water is circulated through the Enhanced Clarifier and GED unit using the Enhanced Clarifier's pump, and
in the Enhanced Clarifier, solids are precipitating from the concentrate water, ion concentration in the concentrate water is being reduced, and the solids are being separated from the concentrate water where they can be removed.

14. When the GED unit is gated ON from its OFF state, the conditions of the GED unit, Enhanced Clarifier, and common ancillary equipment are:
electrical DC power is delivered to the Inert Electrodes contained in the Anolyte and Catholyte Spacers,
dilute water is circulated through the GED and the in-part ancillary equipment consisting of dilute water reservoir and pump,
concentrate waters in each Concentrated Water Spacer is stationary and are electrically and mechanically isolated from the stationary concentrate water in all other Concentrated Water Spacers so that no leakage current can flow in the concentrate water distribution system including the Enhanced Clarifier and its pump,
electrolyte waters in each Anolyte and Catholyte Water Spacer are stationary and are electrically and mechanically isolated from each other so that no leakage current can flow in the electrolyte water distribution system including the in-part ancillary equipment of electrolyte reservoir and pump,
concentrate, dilute, anolyte, and catholyte waters are all electrically and mechanically isolated from each other so that no leakage current or no cross currents can flow in the concentrate, dilute, anolyte, and catholyte waters water distribution systems,
anolyte and cathode waters are a strong electrolyte that form Hydrogen gas at the Cathode and Oxygen gas at the Anode,
ions are being transferred from the dilute waters to the supersaturated concentrate waters in the GED unit,
concentrate waters in the GED unit are being supersaturated in ion content, but remain below the concentration levels where spontaneous precipitation occurs,
ON state lasts on the order of one to three hours or even more in time, and
in the Enhanced Clarifier, solids are precipitating from the concentrate water, ion concentration in the concentrate water is being reduced, and the solids are being separated from the concentrate water where they can be removed.

15. ZLD desalination consisting of:
GED unit, Enhanced Clarifier, and ancillary equipment having the properties and operations described in claims [11], [12], [13] and [14], which in turn were in-part made up from claims [2], [3], [4], [5], [6], [7], [8], [9], and [10],
dilute water is either the feed water to be desalinated or the waste water from a desalination unit or a combination thereof where Reverse Osmosis is an example,
Enhanced Clarifier, which is described in claim [12], with requirement of the concentrate water transient time through it is on the order of tens of hours which provides time for the precipitation and separation of solids from the supersaturated concentrate water as well as decreases the ion concentration in the concentrate water,
Enhanced Clarifier's volume requirement is the product of its concentrate water volume flow rate times the desired transient time in tens of hours where its volume flow rate is defined to be the sum of the volume of concentrate water in all the Concentrate Water Spacers divided by the sum of the time intervals of the ON and OFF states, and
periodically the solids are removed from the Enhanced Clarifier.

16. An alternate electrodialysis stack, which only allows ions to leave but not enter the Anolyte and Catholyte Water Spacers, consisting of:
a cathode assembly is defined as a sequence of Compression Plate, Cover, Catholyte Water Spacer, Anion Ion Exchange Membrane, and Concentrate Water Spacer,
an anode assembly is defined as a sequence of Cation Ion Exchange Membrane, Anolyte Water Spacer, Cover, and Compression Plate,
a middle assembly is defined as a repeating sequence of Cation Ion Exchange Membrane, Dilute Water Spacer, Anion Ion Exchange Membrane, and Concentrate Water Spacer,
the alternate electrodialysis stack consists of a stack of the cathode, middle, and anode assemblies.
